(19) United States
(12) Patent Application Publication
(10) Pub. No.: US 2020/0178048 A1
(43) Pub. Date: Jun. 4, 2020

(54) V2X COMMUNICATION SUPPORT METHOD IN WIRELESS COMMUNICATION SYSTEM

(71) Applicant: LG Electronics Inc., Seoul (KR)

(72) Inventors: Taehun KIM, Seoul (KR); Laeyoung KIM, Seoul (KR)

(21) Appl. No.: 16/334,548

(22) PCT Filed: Sep. 27, 2017
(86) PCT No.: PCT/KR2017/010711

§ 371 Date: Mar. 19, 2019

Related U.S. Application Data
(60) Provisional application No. 62/404,770, filed on Oct. 6, 2016.

(51) Int. Cl. H04W 4/40; H04W 12/06; H04W 48/08

(52) U.S. Cl. CPC H04W 4/40; H04W 48/08; H04W 12/06

(57) ABSTRACT

In a method in which a first UE supports V2X communication of a second UE in a wireless communication system, the method comprises: a step of receiving a first request message, for requesting mapping information with respect to the V2X service, from the second UE; a step of transmitting a second request message, for requesting the mapping information, to a V2X control function; a step of receiving a second response message, comprising the mapping information, from the V2X control function; and a step of creating a first response message comprising the received mapping information and transmitting the first response message to the second UE.

### TECHNICAL FIELD

The present invention relates to a wireless communication system and, more particularly, to a method for supporting V2X communication and an apparatus supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An object of this specification is to propose an effective method for providing a UE with Destination layer-2 ID information mapped to V2X service so that PC5 resource and V2X service management by a network are possible.

Technical objects to be achieved in the present invention are not limited to the aforementioned object, and those skilled in the art to which the present invention pertains will evidently understand other technological objects from the following description.

### Technical Solution

In an aspect of the present invention, a method of supporting vehicle to anything (V2X) communication of a second user equipment (UE) by a first UE in a wireless communication system may include receiving, from the second UE, a first request message to request mapping information on V2X service, wherein the mapping information includes a Destination Layer-2 ID mapped to the V2X service, transmitting, to a V2X control function, a second request message to request the mapping information, receiving, from the V2X control function, a second response message including the mapping information as a response to the second request message, and generating a first response message including the received mapping information and transmitting the first response message to the second UE as a response to the first request message.

Furthermore, the Destination Layer-2 ID may correspond to an identifier for identifying a protocol data unit, provided with respect to the V2X service, by the second UE.

Furthermore, the second request message may include identification information on the second UE.

Furthermore, the second request message may be a message used in a V2X authorization procedure for searching for a V2X communication parameter from the V2X control function.

Furthermore, the reception of the first request message may be configured as a condition for initiating the V2X authorization procedure by the first UE.

Furthermore, the first request message and the first response message may be transmitted through a PC5 reference point, and the second request message and the second response message may be transmitted through a V3 reference point.

Furthermore, the PC5 reference point may correspond to a reference point defined between UEs for the V2X communication, and the V3 reference point may correspond to a reference point defined between a UE and the V2X control function for the V2X authorization.

Furthermore, the V2X communication support method may further include transmitting the mapping information to a third UE at a preset time and/or in a preset period.

Furthermore, information on the preset time and/or the preset period may be received through the second response message.

Furthermore, the second UE the second UE may correspond to a receive-only mode UE or a UE located in out-of-coverage (OOC).

Furthermore, the mapping information may further include identification information on the V2X service, information on the area where the V2X service is used and/or valid period information of the V2X service.

Furthermore, in another aspect of the present invention, a first user equipment (UE) supporting vehicle to anything (V2X) communication of a second UE in a wireless communication system includes a communication module configured to transmit and receive signals and a processor configured to control the communication module. The processor may be configured to receive, from the second UE, a first request message to request mapping information on V2X service, wherein the mapping information includes a Destination Layer-2 ID mapped to the V2X service, transmit, to a V2X control function, a second request message to request the mapping information, receive, from the V2X control function, a second response message including the mapping information as a response to the second request message, and generate a first response message including the received mapping information and transmit the first response message to the second UE as a response to the first request message.

Furthermore, the Destination Layer-2 ID may correspond to an identifier for identifying a protocol data unit, provided with respect to the V2X service, by the second UE.

Furthermore, the second request message may include identification information on the second UE.

Furthermore, the second request message may be a message used in a V2X authorization procedure for searching for a V2X communication parameter from the V2X control function.

### Advantageous Effects

In accordance with an embodiment of the present invention, there is an effect in that stable service provision for a new V2X service can be secured by presenting a detailed method for obtaining mapping information on the new V2X service.

Furthermore, in accordance with an embodiment of the present invention, there is an effect in that the efficient management/operation of PC5 resource and V2X service by a UE and network is possible because the UE and the network are explicitly aware of mapping information on the V2X service.

Effects which may be obtained in the present invention are not limited to the aforementioned effects, and various other effects may be evidently understood by those skilled in the art to which the present invention pertains from the following description.

### DESCRIPTION OF DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a diagram schematically exemplifying an evolved packet system (EPS) to which the present invention can be applied.

FIG. 2 illustrates an example of evolved universal terrestrial radio access network structure to which the present invention can be applied.

FIG. 3 exemplifies a structure of E-UTRAN and EPC in a wireless communication system to which the present invention can be applied.

FIG. 4 illustrates a structure of a radio interface protocol between a UE and E-UTRAN in a wireless communication system to which the present invention can be applied.

FIG. 5 is a diagram schematically showing a structure of a physical channel in a wireless communication system to which the present invention may be applied.

FIG. 6 illustrates 5G system architecture using reference point representation.

FIG. 7 illustrates 5G system architecture using service-based representation.

FIG. 8 illustrates NG-RAN architecture to which the present invention is applicable.

FIG. 9 illustrates a radio protocol stack to which the present invention is applicable.

FIG. 10 illustrates an RM state model to which the present invention is applicable.

FIG. 11 illustrates a CM state model to which the present invention is applicable.

FIG. 12 illustrates classification and user plane marking for QoS flow and mapping of QoS flow to AN resources according to an embodiment of the present invention.

FIG. 13 illustrates the UE component of a receive-only mode with independent unicast according to an embodiment of the present invention.

FIG. 14 illustrates a V2X application server information reception procedure through an MBMS according to an embodiment of the present invention.

FIG. 15 illustrates a method of implementing an RSU, which may be applied to the present invention.

FIG. 16 is a flowchart regarding a method for a first UE to support the V2X communication of a second UE according to an embodiment of the present invention.

FIG. 17 illustrates a block diagram of a communication apparatus according to an embodiment of the present invention.

FIG. 18 illustrates a block diagram of a communication apparatus according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention can be embodied without the specific information.

For some cases, to avoid obscuring the technical principles of the present invention, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present invention, and the specific terms can be used in different ways as long as it does not leave the technical scope of the present invention.

The technology described below can be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA can be implemented by such radio technology as Universal Terrestrial Radio Access (UTRA) or CDMA2000. TDMA can be implemented by such radio technology as Global System for Mobile communications (GSM), General Packet Radio Service (GPRS), or Enhanced Data rates for GSM Evolution (EDGE). OFDMA can be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention can be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention can be supported by the documents above. Also, all of the terms disclosed in this document can be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the UMTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE can be called a terminal, Mobile Equipment (ME), or Mobile Station (MS). A UE can be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a sub-system providing multimedia services based on the IP
International Mobile Subscriber Identity (IMSI): a globally unique subscriber identifier assigned in a mobile communication network
Machine Type Communication (MTC): communication performed by machines without human intervention. It may be called Machine-to-Machine (M2M) communication.
MTC terminal (MTC UE or MTC device): a terminal (for example, a vending machine, meter, and so on) equipped with a communication function operating through a mobile communication network (For example, communicating with an MTC server via a PLMN) and performing an MTC function
MTC server: a server on a network managing MTC terminals. It can be installed inside or outside a mobile communication network. It can provide an interface through which an MTC user can access the server. Also, an MTC server can provide MTC-related services to other servers (in the form of Services Capability Server (SCS)) or the MTC server itself can be an MTC Application Server.
(MTC) application: services (to which MTC is applied) (for example, remote metering, traffic movement tracking, weather observation sensors, and so on)
(MTC) Application Server: a server on a network in which (MTC) applications are performed
MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.
MTC User (MTC User): The MTC user uses the service provided by the MTC server.
MTC subscriber: an entity having a connection relationship with a network operator and providing services to one or more MTC terminals.
MTC group: an MTC group shares at least one or more MTC features and denotes a group of MTC terminals belonging to MTC subscribers.
Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.
External identifier: a globally unique identifier used by an external entity (for example, an SCS or an Application Server) of the 3GPP network to indicate (or identify) an MTC terminal (or a subscriber to which the MTC terminal belongs). An external identifier comprises a domain identifier and a local identifier as described below.
Domain identifier: an identifier used for identifying a domain in the control region of a mobile communication network service provider. A service provider can use a separate domain identifier for each service to provide an access to a different service.
Local identifier: an identifier used for deriving or obtaining an International Mobile Subscriber Identity (IMSI). A local identifier should be unique within an application domain and is managed by a mobile communication network service provider.
Radio Access Network (RAN): a unit including a Node B, a Radio Network Controller (RNC) controlling the Node B, and an eNodeB in the 3GPP network. The RAN is defined at the terminal level and provides a connection to a core network.
Home Location Register (HLR)/Home Subscriber Server (HSS): a database provisioning subscriber information within the 3GPP network. An HSS can perform functions of configuration storage, identity management, user state storage, and so on.
RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).
Public Land Mobile Network (PLMN): a network formed to provide mobile communication services to individuals. The PLMN can be formed separately for each operator.
Non-Access Stratum (NAS): a functional layer for exchanging signals and traffic messages between a terminal and a core network at the UMTS and EPS protocol stack. The NAS is used primarily for supporting mobility of a terminal and a session management procedure for establishing and maintaining an IP connection between the terminal and a PDN GW.
Service Capability Exposure Function (SCEF): An entity within the 3GPP architecture for service capability exposure that provides a means for securely exposing services and capabilities provided by 3GPP network interfaces.

In what follows, the present invention will be described based on the terms defined.

Overview of System to which the Present Invention May be Applied

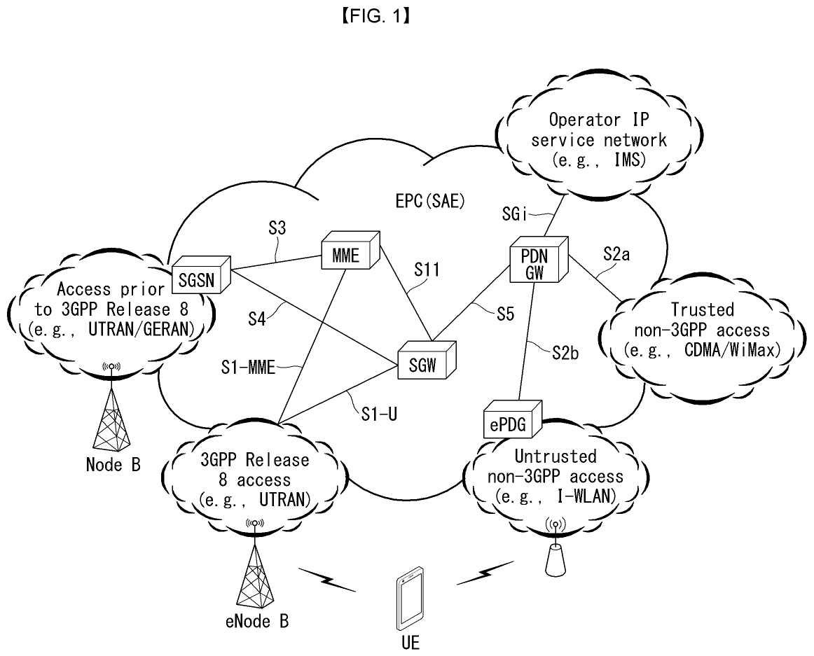

FIG. 1 illustrates an Evolved Packet System (EPS) to which the present invention can be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities can be established through an IP-based base station (for example, eNodeB), EPC, and application domain (for example, IMS). In other words, the EPC provides the architecture essential for implementing end-to-end IP services.

The EPC comprises various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, in case the UE moves across serving areas by the eNodeB, the SGW acts as an anchor point for local mobility. In other words, packets can be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW can support policy enforcement features, packet filtering, charging support, and so on. Also, the PDN GW can act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways can be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability can access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points can be defined according to network structures.

TABLE 1

| Reference | |
|---|---|
| point | Description |
| S1-MME | Reference point for the control plane protocol between |
| | E-UTRAN and MME |
| S1-U | Reference point between E-UTRAN and Serving GW for the |
| | per bearer user plane tunneling and inter eNodeB path |
| | switching during handover |
| S3 | It enables user and bearer information exchange for |
| | inter 3GPP access network mobility in idle and/or |
| | active state. This reference point can be used |
| | intra-PLMN or inter-PLMN (e.g. in the case of |
| | Inter-PLMN HO). |
| S4 | It provides related control and mobility support |
| | between GPRS core and the 3GPP anchor function of |
| | Serving GW. In addition, if direct tunnel is not |
| | established, it provides the user plane tunneling. |
| S5 | It provides user plane tunneling and tunnel management |
| | between Serving GW and PDN GW. It is used for Serving |
| | GW relocation due to UE mobility if the Serving GW |
| | needs to connect to a non-collocated PDN GW for the |
| | required PDN connectivity. |
| S11 | Reference point for the control plane protocol between |
| | MME and SGW |
| SGi | It is the reference point between the PDN GW and the |
| | packet data network. Packet data network may be an |
| | operator external public or private packet data |
| | network or an intra-operator packet data network |
| | (e.g., for provision of IMS services). This reference |
| | point corresponds to Gi for 3GPP accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

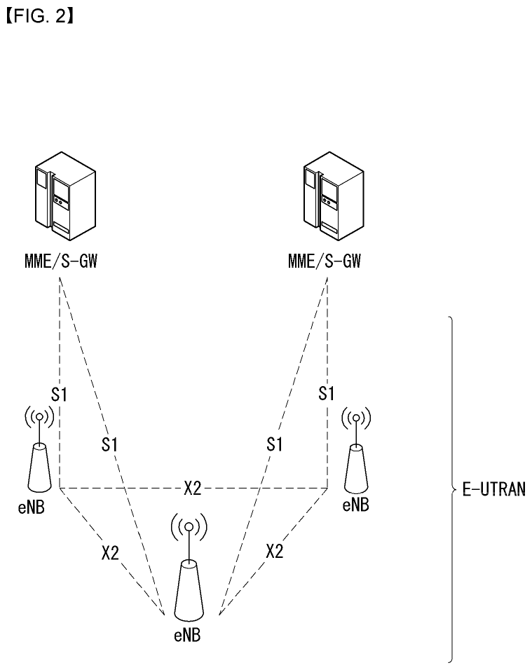

FIG. 2 illustrates one example of an Evolved Universal Terrestrial Radio Access Network (E-UTRAN) to which the present invention can be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

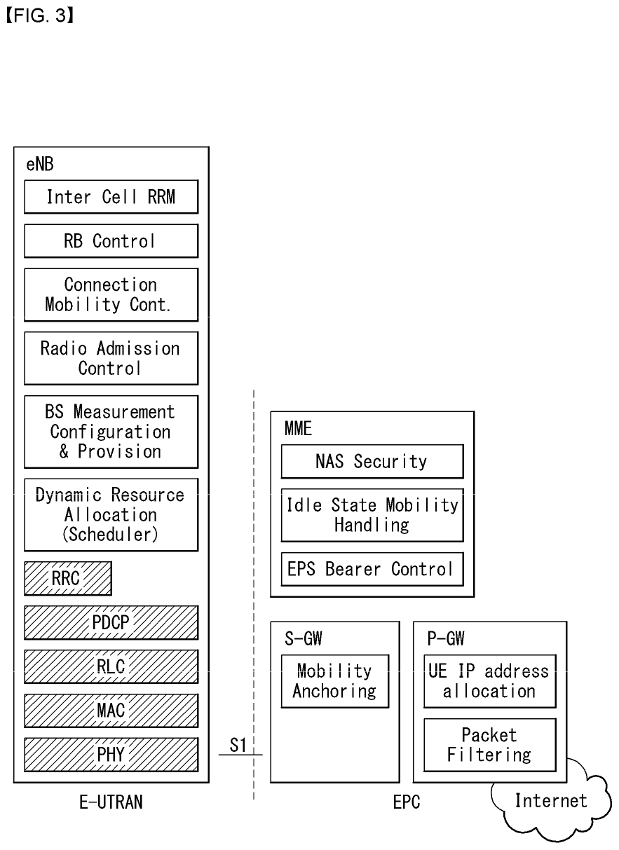

FIG. 3 exemplifies a structure of E-UTRAN and EPC in a wireless communication system to which the present invention can be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

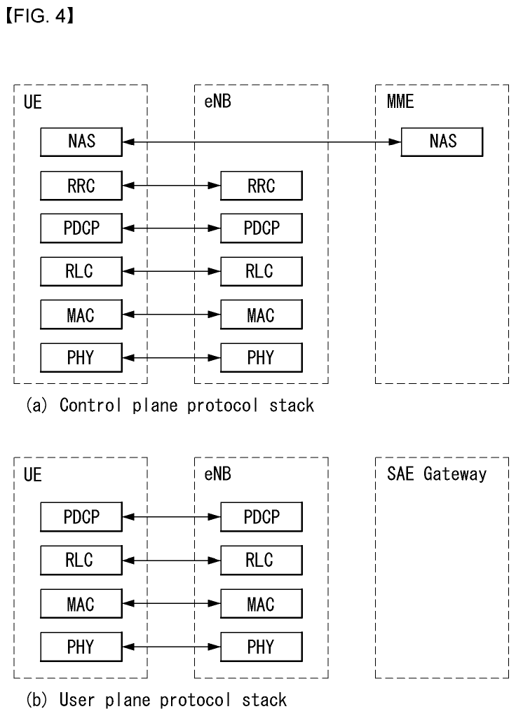

FIG. 4 illustrates a radio interface protocol structure between a UE and an E-UTRAN in a wireless communication system to which the present invention can be applied.

FIG. 4(a) illustrates a radio protocol structure for the control plane, and FIG. 4(b) illustrates a radio protocol structure for the user plane.

With reference to FIG. 4, layers of the radio interface protocol between the UE and the E-UTRAN can be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH can carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, in case the MAC layer performs the RLC function, the RLC layer can be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers can be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells can be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service can be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

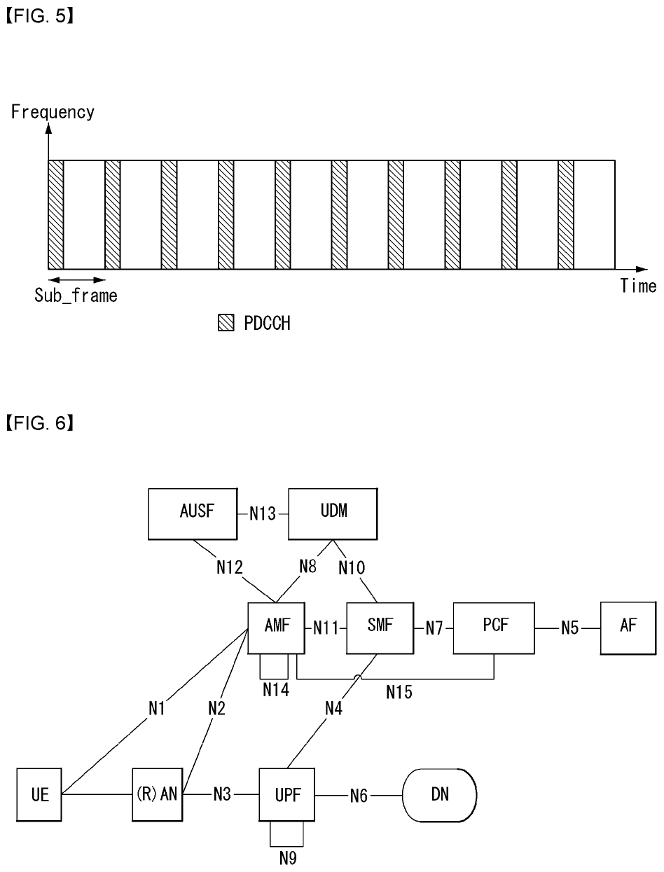

FIG. 5 is a diagram schematically exemplifying a structure of physical channel in a wireless communication system to which the present invention can be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

New Generation Radio Access Network (NG-RAN) (or RAN) System

Terms used in a NG-RAN may be defined as follows.
Evolved Packet System (EPS): a network system including an evolved packet core (EPC), that is an Internet protocol (IP) based packet switched core network, and an access network such as LTE and UTRAN. The EPS is a network of an evolved version of a universal mobile telecommunications system (UMTS).
eNodeB: a base station of an EPS network. The eNodeB is installed outdoor, and its coverage has a scale of a macro cell.
International Mobile Subscriber Identity (IMSI): an internationally unique subscriber identity allocated in a mobile communication network.
Public Land Mobile Network (PLMN): a network configured for the purpose of providing mobile communication services to individuals. The PLMN can be configured for each operator.
5G System (5GS): a system composed of a 5G access network (AN), a 5G core network, and a user equipment (UE).
5G Access Network (5G-AN) (or AN): an access network composed of a new generation radio access network (NG-RAN) and/or a non-3GPP access network (AN) connected to the 5G core network.
New Generation Radio Access Network (NG-RAN) (or RAN): a radio access network having a common feature of being connected to 5GC and supporting one or more of the following options:

1) Standalone new radio.

2) New radio that is an anchor supporting E-UTRA extension.

3) Standalone E-UTRA (for example, eNodeB).

4) Anchor supporting new radio extension
5G core network (5GC): a core network connected to a 5G access network.
Network Function (NF): means a processing function adopted in 3GPP within a network or defined in 3GPP. The processing function includes a defined functional behavior and an interface defined in 3GPP.
NF service: a function exposed by the NF via a service-based interface and consumed by other authenticated NF(s).
Network Slice: a logical network that provides specific network capability(s) and network feature(s).
Network Slice instance: a set of NF instance(s) and required resource(s) (e.g., compute, storage, and networking resources) that form a deployed network slice.
Protocol Data Unit (PDU) Connectivity Service: service providing the exchange of PDU(s) between the UE and a data network.
PDU Session: association between the UE and the data network that provide the PDU connectivity service. An association type may be Internet protocol (IP), Ethernet, or unstructured.
Non-Access Stratum (NAS): a functional layer for transceiving signaling and a traffic message between the UE and the core network in EPS and 5GS protocol stack. The NAS mainly functions to support mobility of the UE and support a session management procedure.

5G System Architecture to which the Present Invention is Applicable

A 5G system is an advanced technology from 4G LTE mobile communication technology and supports a new radio access technology (RAT), extended Long Term Evolution (eLTE) as an extended technology of LTE, non-3GPP access (e.g., wireless local area network (WLAN) access), etc. through the evolution of an existing mobile communication network structure or a clean-state structure.

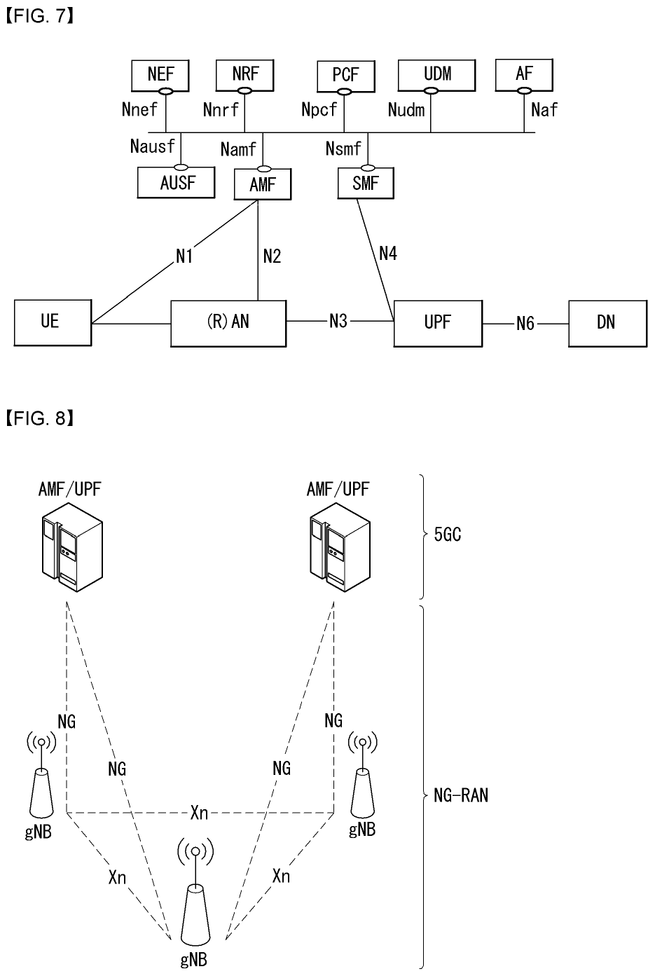

The 5G system is defined based on a service, and an interaction between Network Functions (NFs) in an architecture for the 5G system can be represented in two ways as follows.
Reference point representation (see FIG. 6): indicates an interaction between NF services in NFs described by a point-to-point reference point (e.g., N11) between two NFs (e.g. AMF and SMF).
Service-based representation (see FIG. 7): network functions (e.g., AMF) within a Control Plane (CP) allow other authenticated network functions to access its services. The representation also includes a point-to-point reference point, if necessary.

FIG. 6 illustrates a 5G system architecture using reference point representation.

Referring to FIG. 6, the 5G system architecture may include various components (i.e., network functions (NFs)). FIG. 6 illustrates some of the various components, for example, an Authentication Server Function (AUSF), a (Core) Access and Mobility Management Function (AMF), a Session Management Function (SMF), a Policy Control function (PCF), an Application Function (AF), a Unified Data Management (UDM), Data network (DN), User plane Function (UPF), a (Radio) Access Network ((R)AN), and a User Equipment (UE).

Respective NFs support the following functions.
The AUSF stores data for the authentication of the UE.
The AMF provides a function for the connection and mobility management for each UE, and one AMF can be basically connected to one UE.

More specifically, the AMF supports functions of inter-CN node signaling for mobility between 3GPP access networks, termination of RAN CP interface (i.e., N2 interface), termination N1 of NAS signaling, NAS signaling security (NAS ciphering and integrity protection), AS security control, registration management (registration area management), connection management, idle mode UE reachability (including control and execution of paging retransmission), mobility management control (subscription and policy), support of intra-system mobility and inter-system mobility, support of network slicing, SMF selection, lawful intercept (for an interface to AMF event and L1 system), providing the delivery of a session management (SM) message between UE and SMF, transparent proxy for routing the SM message, access authentication, access authorization including roaming authority check, providing the delivery of a SMS message between UE and SMSF, Security Anchor Function (SEA) and/or Security Context Management (SCM), and the like.

Some or all of the functions of the AMF can be supported in a single instance of one AMF.
The DN means, for example, operator services, internet access, or 3rd party service. The DN transmits a downlink Protocol Data Unit (PDU) to the UPF or receives the PDU transmitted from the UE from the UPF.
The PCF receives information about packet flow from an application server and provides functions of determining policies such as mobility management and session management. More specifically, the PCF supports functions of supporting a unified policy framework for controlling a network operation, providing a policy rule so that CP function(s) (e.g., AMF, SMF, etc.) can enforce the policy rule, and implementing a front end for accessing related subscription information for policy decision in a User Data Repository (UDR).
The SMF provides a session management function. If the UE has a plurality of sessions, the sessions can be respectively managed by different SMFs.

More specifically, the SMF supports functions of session management (e.g., session establishment, modification, and release, including tunnel maintenance between the UPF and the AN node), UE IP address allocation and management (including optional authentication), selection and control of UP function, configuring traffic steering at UPF to route traffic to proper destination, termination of interfaces toward policy control functions, enforcement of control part of a policy and QoS, lawful intercept (for an interface to SM event and L1 system), termination of SM part of a NAS message, downlink data notification, an initiator of AN specific SM information (sent to AN via the AMF over N2), SSC mode decision of the session, a roaming function, and the like.

Some or all of the functions of the SMF can be supported within a single instance of one SMF.
The UDM stores subscription data of user, policy data, etc. The UDM includes two parts, i.e., application front end (FE) and User Data Repository (UDR).

The FE includes UDM FE taking charge of location management, subscription management, processing of credential, etc. and PCF taking charge of policy control. The UDR stores data required for functions provided by the UDM-FE and a policy profile required by the PCF. Data stored in the UDR includes user subscription data including subscription identifier, security credential, access and mobility related subscription data, and session related subscription data and policy data. The UDM-FE accesses subscription information stored in the UDR and supports functions of Authentication Credential Processing, User Identification Handling, access authentication, registration/mobility management, subscription management, SMS management, and the like.
The UPF transmits the downlink PDU received from the DN to the UE via the (R)AN and transmits the uplink PDU received from the UE to the DN via the (R)AN.

More specifically, the UPF supports functions of anchor point for intra/inter RAT mobility, external PDU session point of interconnect to Data Network (DN), packet routing and forwarding, packet inspection and user plane part of policy rule enforcement, lawful intercept, reporting of traffic usage, uplink classifier to support routing traffic flow to Data Network (DN), branching point to support multi-homed PDU session, QoS handling (e.g., packet filtering, gating, uplink/downlink rate enforcement) for user plane, uplink traffic verification (SDF mapping between service data flow (SDF) and QoS flow), transport level packet marking in the uplink and downlink, downlink packet buffering and downlink data notification triggering, and the like. Some or all of the functions of the UPF can be supported in a single instance of one UPF.
AF interacts with 3GPP core network to provide services (e.g., support functions of an application influence on traffic routing, network capability exposure access, interaction with policy framework for policy control, and the like).
(R)AN collectively refers to a new radio access network supporting both evolved E-UTRA, that is an evolved version of 4G radio access technology, and a New Radio (NR) access technology (e.g., gNB).

gNB supports functions of radio resource management function (i.e., radio bearer control, radio admission control, connection mobility control, dynamic allocation of resources to the UE in uplink/downlink (scheduling)), Internet protocol (IP) header compression, encryption of user data stream and integrity protection, selection of AMF upon attachment of the UE if routing to the AMF is not determined from information provided to the UE, routing of user plane data to UPF(s), routing of control plane information to ANF, connection setup and release, scheduling and transmission of a paging message (generated from the AMF), scheduling and transmission of system broadcast information (generated from the AMF or operating and maintenance (O&M)), measurement and measurement reporting configuration for mobility and scheduling, transport level packet marking in uplink, session management, support of network slicing, QoS flow management and mapping to data radio bearer, support of a UE in an inactive mode, NAS message distribution function, NAS node selection function, radio access network sharing, dual connectivity, tight interworking between NR and E-UTRA, and the like.
The UE means a user equipment. The user equipment may be referred to as a term such as a terminal, a mobile equipment (ME), and a mobile station (MS). The user equipment may be a portable device such as a notebook computer, a cellular phone, a personal digital assistant (PDA), a smart phone, and a multimedia device, or a non-portable device such as a personal computer (PC) and a vehicle-mounted device.

Although unstructured data storage network function (UDSF), structured data storage network function (SDSF), network exposure function (NEF), and NF repository function (NRF) are not shown in FIG. 6 for clarity of explanation, all the NFs shown in FIG. 6 can perform interaction with the UDSF, the NEF and the NRF, if necessary.
The NEF provides a means to securely expose services and capabilities provided by 3GPP network functions, for example, 3rd party, internal exposure/re-exposure, application function, and edge computing. The NEF receives information from other network function(s) (based on exposed capabilities of other network function(s)). The NEF can store the received information as structured data using a standardized interface to a data storage network function. The stored information can be re-exposed by the NEF to other network functions and other application functions and can be used for other purposes such as analysis.
The NRF supports a service discovery function. The NRF receives NF Discovery Request from NF instance and provides information of the discovered NF instance to the NF instance. The NRF also maintains available NF instances and their supported services.
The SDSF is structured data by any NEF and is a selective function to support a storage and retrieval function of information.
The UDSF is unstructured data by any NF and is a selective function to support a storage and retrieval function of information.

FIG. 6 illustrates a reference model where the UE accesses one DN using one PDU session, for convenience of explanation. However, the present invention is not limited thereto.

The UE can simultaneously access two (i.e., local and central) data networks using multiple PDU sessions. In this instance, two SMFs may be selected for different PDU sessions. Each SMF may have a capability capable of controlling both local UPF and central UPF within the PDU session.

Further, the UE can simultaneously access two (i.e., local and central) data networks provided within a single PDU session.

In the 3GPP system, a conceptual link connecting between the NFs in the 5G system is defined as a reference point. The following illustrates reference points included in the 5G system architecture as represented in FIG. 6.
N1: Reference point between the UE and the AMF
N2: Reference point between the (R)AN and the AMF
N3: Reference point between the (R)AN and the UPF
N4: Reference point between the SMF and the UPF
N5: Reference point between the PCF and the AF
N6: Reference point between the UPF and the data network
N7: Reference point between the SMF and the PCF
N24: Reference point between the PCF in the visited network and the PCF in the home network
N8: Reference point between the UDM and the AMF
N9: Reference point between two core UPFs
N10: Reference point between the UDM and the SMF
N11: Reference point between the AMF and the SMF
N12: Reference point between the AMF and the AUSF
N13: Reference point between UDM and Authentication Server function (AUSF)
N14: Reference point between two AMFs
N15: Reference point between the PCF and the AMF in case of non-roaming scenario, reference point between PCF in the visited network and AMF in case of roaming scenario
N16: Reference point between two SMFs (reference point between the SMF in the visited network and the SMF in the home network in case of roaming scenario)
N17: Reference point between AMF and EIR
N18: Reference point between any NF and UDSF
N19: Reference point between NEF and SDSF

FIG. 7 illustrates a 5G system architecture using service-based representation.

Service-based interfaces illustrated in FIG. 7 indicate a set of services provided/exposed by a predetermined NF. The service-based interfaces are used in control plane. The following illustrates the service-based interfaces included in the 5G system architecture as represented in FIG. 6.
Namf: Service-based interface exhibited by the AMF
Nsmf: Service-based interface exhibited by the SMF
Nnef: Service-based interface exhibited by the NEF
Npcf: Service-based interface exhibited by the PCF
Nudm: Service-based interface exhibited by the UDM
Naf: Service-based interface exhibited by the AF
Nnrf: Service-based interface exhibited by the NRF
Nausf: Service-based interface exhibited by the AUSF

The NF service is one type of capability exposed by an NF (i.e., NF service producer) to other NF (i.e., NF service consumer) via the service-based interface. The NF can expose one or more NF service(s). The following standard is applied to define the NF service.
The NF services are derived from information flow for explaining an end-to-end function.
Complete end-to-end message flow is explained by a sequence of NF service invocation.
Two operations that the NF(s) provide its services via the service-based interface are as follows:

i) “Request-response”: A control plane NF_B (i.e., NF service producer) is requested from another control plane NF_A (i.e., NF service consumer) to provide a certain NF service (including performing an operation and/or providing information). The NF_B responses NF service result based on information provided by the NF_A in the Request.

In order to fulfill the request, the NF_B may in turn consume NF services from other NF(s). In Request-response mechanism, communication is performed one to one between two NFs (i.e., consumer and producer).

ii) “Subscribe-Notify”

A control plane NF_A (i.e., NF service consumer) subscribes to a NF service provided by another control plane NF_B (i.e., NF service producer). Multiple control plane NFs may subscribe to the same control plane NF service. The NF_B notifies a result of this NF service to the interested NFs that are subscribed to this NF service. A subscription request from the consumer may include a notification request for periodic update or notification triggered through specific events (e.g., change of requested information, reaching a certain critical value, etc.). This mechanism also includes the case where the NF(s) (e.g., NF_B) implicitly subscribes to a specific notice without an explicit subscription request (e.g., the case where the NF(s) subscribes through a successful registration procedure).

FIG. 8 illustrates an NG-RAN architecture to which the present invention is applicable.

Referring to FIG. 8, a new generation radio access network (NG-RAN) includes gNB (NR NodeB)(s) and/or eNB (eNodeB)(s) providing a user plane toward a UE and termination of control plane protocol.

The gNB(s) are interconnected using an Xn interface, and the eNB(s) connected to the gNB(s) and 5GC are also interconnected using the Xn interface. The gNB(s) and the eNB(s) are connected to the 5GC using an NG interface. More specifically, the gNB(s) and the eNB(s) are connected to the AMF using an NG-C interface (i.e., N2 reference point) that is a control plane interface between the NG-RAN the 5GC, and are connected to the UPF using an NG-U interface (i.e., N3 reference point) that is a user plane interface between the NG-RAN and the 5GC.

Radio Protocol Architecture

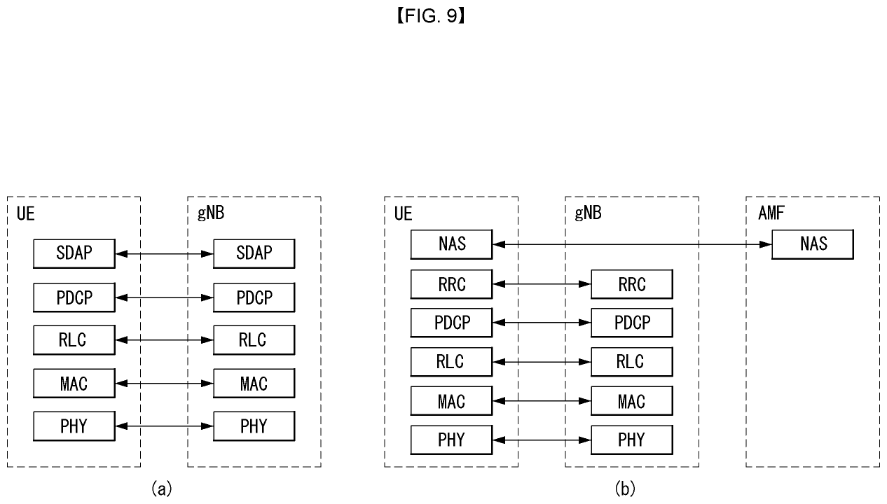

FIG. 9 illustrates a radio protocol stack to which the present invention is applicable. More specifically, FIG. 9(a) illustrates a radio interface user plane protocol stack between a UE and gNB, and FIG. 9(b) illustrates a radio interface control plane protocol stack between the UE and the gNB.

The control plane means a path through which control messages used for a UE and a network to manage calls are transmitted. The user plane means a path through which data generated in an application layer, for example, voice data, Internet packet data, and so on are transmitted.

Referring to FIG. 9(a), the user plane protocol stack may be divided into Layer 1 (i.e., physical (PHY) layer) and Layer 2.

Referring to FIG. 9(b), the control plane protocol stack may be divided into Layer 1 (i.e., PHY layer), Layer 2, Layer 3 (i.e., radio resource control (RRC) layer), and a non-access stratum (NAS) layer.

The Layer 2 is divided into a medium access control (MAC) sublayer, a radio link control (RLC) sublayer, a packet data convergence protocol (PDC) sublayer, and a service data adaptation protocol (SDAP) sublayer (in case of the user plane).

A radio bearer is classified into two groups: data radio bearer (DRB) for user plane data and signaling radio bearer (SRB) for control plane data.

Each layer of the control plane and the user plane of the radio protocol is described below.

1) The Layer 1, i.e., the PHY layer, provides information transfer service to an upper layer by using a physical channel. The PHY layer is connected to the MAC sublayer located at an upper level through a transport channel, and data are transmitted between the MAC sublayer and the PHY layer through the transport channel. The transport channel is classified according to how and which feature data is transmitted via a radio interface. And, data is transmitted between different PHY layers, between a PHY layer of a transmitter and a PHY layer of a receiver, through a physical channel.

2) The MAC sublayer performs mapping between a logical channel and a transport channel; multiplexing/demultiplexing of MAC service data unit (SDU) belonging to one or different logical channel(s) to/from a transport block (TB) delivered to/from the PHY layer through a transport channel; scheduling information reporting; error correction through hybrid automatic repeat request (HARQ); priority handling between UEs using dynamic scheduling; priority handling between logical channels of one UE using logical channel priority; and padding.

Different kinds of data deliver a service provided by the MAC sublayer. Each logical channel type defines what type of information is delivered.

The logical channel is classified into two groups: a control channel and a traffic channel.

i) The Control Channel is used to deliver only control plane information and is as follows.
Broadcast Control Channel (BCCH): a downlink channel for broadcasting system control information.
Paging Control Channel (PCCH): a downlink channel that delivers paging information and system information change notification.
Common Control Channel (CCCH): a channel for transmitting control information between a UE and a network. This channel is used for UEs having no RRC connection with the network.
Dedicated Control Channel (DCCH): a point-to-point bi-directional channel for transmitting dedicated control information between the UE and the network. This channel is used by the UE having an RRC connection.

ii) The traffic channel is used to use only user plane information.
Dedicated Traffic Channel (DTCH): a point-to-point channel, dedicated to a single UE, for delivering user information. The DTCH may exist in both uplink and downlink.

In the downlink, connection between the logical channel and the transport channel is as follows.

The BCCH may be mapped to BCH. The BCCH may be mapped to DL-SCH. The PCCH may be mapped to PCH. The CCCH may be mapped to the DL-SCH. The DCCH may be mapped to the DL-SCH. The DTCH may be mapped to the DL-SCH.

In the uplink, connection between the logical channel and the transport channel is as follows. The CCCH may be mapped to UL-SCH. The DCCH may be mapped to the UL-SCH. The DTCH may be mapped to the UL-SCH.

3) The RLC sublayer supports three transmission modes: a transparent mode (TM), an unacknowledged mode (UM), and an acknowledged mode (AM).

The RLC configuration may be applied for each logical channel. In case of SRB, the TM or the AM is used. On the other hand, in case of DRB, the UM the AM is used.

The RLC sublayer performs the delivery of the upper layer PDU; sequence numbering independent of PDCP; error correction through automatic repeat request (ARQ); segmentation and re-segmentation; reassembly of SDU; RLC SDU discard; and RLC re-establishment.

4) A PDCP sublayer for the user plane performs sequence numbering; header compression and decompression (robust header compression (RoHC) only); delivery of user data; reordering and duplicate detection (if the delivery to a layer above the PDCP is required); PDCP PDU routing (in case of a split bearer); re-transmission of PDCP SDU; ciphering and deciphering; PDCP SDU discard; PDCP re-establishment and data recovery for RLC AM; and duplication of PDCP PDU.

The PDCP sublayer for the control plane additionally performs Sequence Numbering; ciphering, deciphering and integrity protection; delivery of control plane data; duplicate detection; and duplication of PDCP PDU.

When duplication is configured for a radio bearer by RRC, an additional RLC entity and an additional logical channel are added to the radio bearer to control the duplicated PDCP PDU(s). The duplication at PDCP includes transmitting the same PDCP PDUs twice. Once it is transmitted to the original RLC entity, and a second time it is transmitted to the additional RLC entity. In this instance, the original PDCP PDU and the corresponding duplicate are not transmitted to the same transport block. Two different logical channels may belong to the same MAC entity (in case of CA) or different MAC entities (in case of DC). In the former case, logical channel mapping restriction is used to ensure that the original PDCP PDU and the corresponding duplicate are not transmitted to the same transport block.

5) The SDAP sublayer performs i) mapping between QoS flow and data radio bearer, and ii) QoS flow identification (ID) marking in downlink and uplink packet.

A single protocol entity of SDAP is configured for each individual PDU session, but exceptionally, in case of dual connectivity (DC), two SDAP entities can be configured.

6) A RRC sublayer performs broadcast of system information related to access stratum (AS) and non-access stratum (NAS); paging initiated by 5GC or NG-RAN; establishment, maintenance and release of RRC connection between UE and NG-RAN (additionally including modification and release of carrier aggregation and also additionally including modification and release of dual connectivity between E-UTRAN and NR or in NR); security function including key management; establishment, configuration, maintenance and release of SRB(s) and DRB(s); delivery of handover and context; UE cell selection and re-release and control of cell selection/reselection: mobility function including inter-RAT mobility; QoS management function, UE measurement reporting and control of reporting; detection of radio link failure and recovery from radio link failure; and NAS message delivery from NAS to UE and NAS message delivery from UE to NAS.

Network Slicing

The 5G system has introduced a network slicing technology providing network resources and network functions as individual slices according to each service.

With the introduction of network slicing, isolation, independent management, etc. of a network function and a network resource may be provided per each slice. Hence, the network slicing may select and combine network functions of the 5G system according to services, users, etc., thereby providing independent and more flexible services per the service and the user

The network slice refers to a logically combined network of an access network and a core network.

The network slice may include one or more of the following:
core network control plane and user plane function
NG-RAN
non-3GPP interworking function (N3IWF) of non-3GPP access network

Supported function and network function optimization may differ per each network slice. Multiple network slice instances may provide the same function for different groups of UEs.

A single UE may be simultaneously connected to one or more network slice instances via a 5G-AN. The single UE may be served by at most eight network slices at a time. An AMF instance serving the UE may belong to each network slice instance serving the UE. That is, the AMF instance may be common to the network slice instance serving the UE. CN part of the network slice instance(s) serving the UE is selected by the CN.

One PDU session belongs to only one specific network slice instance per PLMN. Different network slice instances do not share the one PDU session.

One PDU session belongs to one specific network slice instance per PLMN. Different slices may have slice-specific PDU sessions using the same DNN, but different network slice instances do not share the one PDU session.

Single network slice selection assistance information (S-NSSAI) identifies a network slice. Each S-NSSAI is assistance information used for a network to select a specific network slice instance. NSSAI is a set of S-NSSAI(s). The S-NSSAI includes the following:
Slice/service type (SST): SST indicates an expected operation of the network slice in terms of function and service.
Slice differentiator (SD): SD is optional information that complements SST(s) for selecting a network slice instance from a plurality of potentially network slice instances that complies with all of the indicated SSTs.

1) Network Slice Selection Upon Initial Connection

A UE may be configured with a configured NSSAI per PLMN by home PLMN (HPLMN). The configured NSSAI is PLMN-specific, and the HPLMN indicates PLMN(s) to which each configured NSSAI is applied.

Upon initial connection of the UE, an RAN selects an initial network slice which will send a message using the NSSAI. To this end, in a registration procedure, the UE provides a requested NSSAI to a network. When the UE provides the requested NSSAI to the network, the UE in a predetermined PLMN uses only S-NSSAIs belonging to the configured NSSAI of a corresponding PLMN.

If the UE does not provide the NSSAI to the RAN or the RAN does not select a proper network slice according to the provided NSSAI, the RAN may select a default network slice.

Subscription data include S-NSSAI(s) of network slice(s) to which the UE subscribes. One or more S-NSSAIs may be marked as default S-NSSAI. If the S-NSSAI is marked as default, the network can serve the UE with the related network slice even when the UE does not send any S-NSSAI to the network in a registration request.

If the UE is successfully registered, a CN informs (R)AN by providing whole allowed NSSAI (including one or more S-NSSAIs). Further, when a registration procedure of the UE is successfully completed, the UE may obtain the allowed NSSAI for this PLMN from the AMF.

The allowed NSSAI takes precedence over the configured NSSAI for this PLMN. The UE uses only the S-NSSAI(s) in the allowed NSSAI corresponding to a network slice for a subsequent network slice selection related procedure in the serving PLMN.

For each PLMN, the UE stores the configured NSSAI and the Allowed NSSAI (if any). When the UE receives an Allowed NSSAI for a PLMN, it overrides a previously stored allowed NSSAI for this PLMN.

2) Slice Change

A network can change an already selected network slice instance according to a local policy, UE mobility, change in subscription information, etc. That is, a set of network slices for the UE can be changed at any time while the UE is registered with the network. Further, change in the set of network slices for the UE may be initiated by the network or the UE under specific conditions.

Based on a local policy, change in subscription information, and/or UE mobility, the network may change a set of permitted network slice(s) to which the UE is registered. The network may perform such change during a registration procedure or notify the UE of change in supported network slice(s) using a procedure which can trigger a registration procedure.

Upon change of the network slice, the Network may provide the UE with a new allowed NSSAI and a tracking area list. The UE includes a new NSSAI in signaling according to a mobility management procedure to transmit it and thus causes reselection of a slice instance. According to the change of the network slice, an AMF supporting this may be changed.

If the UE enters an area where a network slice is no longer available, a core network releases PDU sessions for an S-NSSAI corresponding to a network slice that is no longer available via a PDU session release procedure.

When the PDU sessions corresponding to a slice that is no longer available are released, the UE uses a UE policy to determine whether an existing traffic can be routed over PDU sessions belonging to other slices.

In order to change a set of S-NSSAI(s) being used, the UE initiates a registration procedure.

3) SMF Selection

A PCF provides a network slice selection policy (NSSP) to the UE. The NSSP associates the UE with an S-NSSAI and is used by the UE so as to determine PDU sessions when a traffic is routed.

The NSSP is provided per application of the UE, and it includes a rule capable of mapping the S-NSSAI per the UE application. An AMF selects a SMF for PDU session management using subscription information, a local provider policy, etc. together with SM-NSSAI and DNN information delivered by the UE.

When a PDU session for a specific slice instance is established, the CN provides the (R)AN with the S-NSSAI corresponding to the slice instance to which the PDU session belongs so that the RAN can access a specific function of the slice instance.

Session Management

The 5GC supports a PDU connectivity service, i.e., a service that provides exchange of PDU(s) between a UE and a data network (DN) identified by a data network name (DNN) (or access point name (APN)). The PDU connectivity service is supported via PDU sessions that are established upon request from the UE.

Each PDU session supports a single PDU session type. That is, each PDU session supports the exchange of a single type of PDU requested by the UE upon establishment of the PDU session. The following PDU session type is defined: IP version 4 (IPv4), IP version 6 (IPv6), Ethernet, and unstructured. Here, the type of PDU exchanged between the UE and the DN is completely transparent to the 5G system.

The PDU sessions are established (upon UE requests), modified (upon UE and 5GC request), and released (upon UE and 5GC request) using NAS SM signaling exchanged over N1 between the UE and a SMF. Upon request from an application server, the 5GC can trigger a specific application in the UE. If the UE receives a trigger message, the UE may deliver the corresponding message to an identified application, and the identified application may establish a PDU session to a specific DNN.

The SMF checks whether the UE request is compliant with user subscription information. To this end, the SMF obtains SMF level subscription data from an UDM. Such data may indicate the allowed PDU session type per DNN.

The UE that is registered over multiple accesses selects an access for establishing a PDU session.

The UE may request to move a PDU session between 3GPP and non-3GPP accesses. A decision to move the PDU session between the 3GPP and non-3GPP accesses is made on a per PDU session basis. That is, the UE may have PDU sessions using the 3GPP access while other PDU sessions use the non-3GPP access.

In a PDU session establishment request transmitted from the network, the UE provides a PDU session identity (Id). The UE may also provide a PDU session type, slicing information, DNN, and a service and session continuity (SSC) mode.

The UE may simultaneously establish multiple PDU sessions via the 3GPP access and/or the non-3GPP access with the same DN or different DNs.

The UE may establish multiple PDU sessions with the same DN served by different UPF terminations N6.

The UE having the multiple established PDU sessions may be served by different SMFs.

A user plane path of different PDU sessions (with the same DNN or different DNNs) belonging to the same UE may be completely separated between the UPF interfacing with the DN and the AN.

The 5G system architecture can satisfy various continuity requirements of different applications/services in the UE by supporting session and service continuity (SSC). The 5G system supports different SSC modes. A SSC mode related to a PDU session anchor is not changed while the PDU session is established.
In case of a PDU session to which SSC mode 1 is applied, the network preserves the connectivity service provided to the UE. In case of a PDU session of IP type, an IP address is preserved.
In case of using SSC mode 2, the network may release the connectivity service delivered to the UE and also release the corresponding PDU session. In case of a PDU session of IP type, the network may release IP address(es) that had been allocated to the UE.
In case of using SSC mode 3, changes in the user plane is visible to the UE, while the network ensures that the UE suffers no loss of connectivity. A connection through a new PDU session anchor point is established before the previous connection is terminated, in order to allow for better service continuity. In case of a PDU session of IP type, the IP address is not preserved in this mode during relocation of the anchor.

A SSC mode selection policy is used to determine a type of SSC mode associated with an application (or application group) of the UE. An operator may previously configure the SSC mode selection policy to the UE. This policy includes one or more SSC mode selection policy rules which can be used by the UE to determine a type of SSC mode associated with an application (or application group). This policy may also include a default SSC mode selection policy rule that can be applied to all applications of the UE.

If the UE provide an SSC mode when requesting a new PDU session, the SMF selects either accepting the requested SSC mode or modifying the requested SSC mode based on subscription information and/or local configuration. If the UE does not provide an SSC mode when requesting a new PDU session, the SMF selects a default SSC mode for data network listed in the subscription information or applies local configuration for selecting the SSC mode.

The SMF informs the UE of the selected SSC mode for the PDU session.

Mobility Management

Registration management (RM) is used to register or de-register the UE/user to a network and establish user context in the network.

1) Registration Management

The UE/user needs to register with the network to receive service that requires registration. After the registration is performed once, if applicable, the UE can update its registration to the network to periodically maintain the reachability (i.e., periodic registration update), or update its capability or re-negotiate protocol parameters upon movement (mobility registration update).

An initial registration procedure includes execution of a network access control function (i.e., user authentication and access authentication based on a subscription profile in the UDM). As a result of the registration procedure, identification of serving AMF is registered in the UDM.

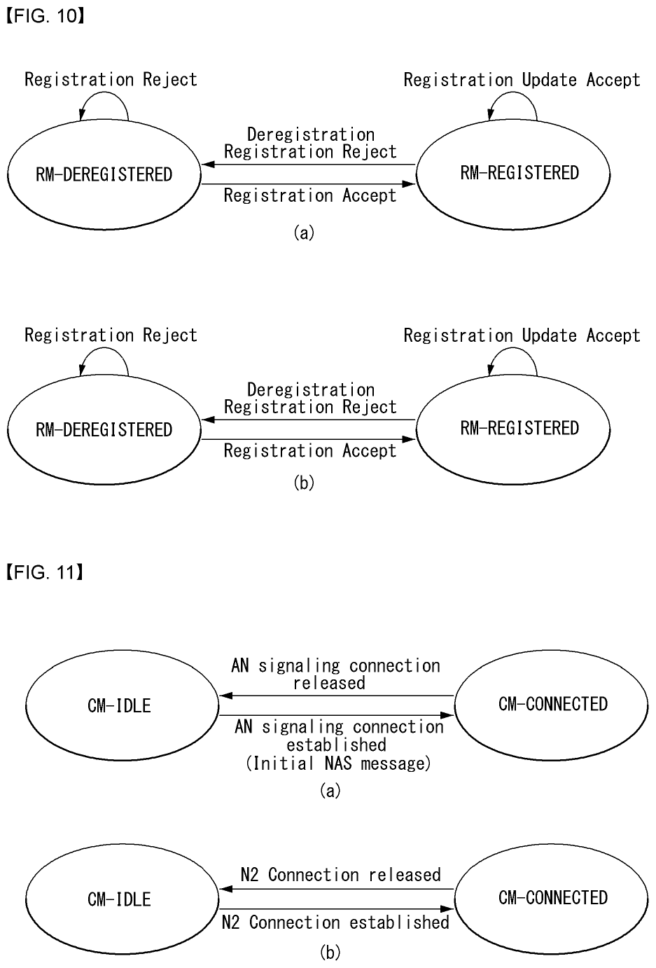

FIG. 10 illustrates a RM state model to which the present invention is applicable. More specifically, FIG. 10(a) illustrates a RM state model in the UE, and FIG. 10(a) illustrates a RM state model in the AMF.

Referring to FIG. 10, two RM states of RM-DEREGISTERED and RM-REGISTERED are used in the UE and the AMF to reflect a registration state of the UE in selected PLMN.

In the RM-DEREGISTERED state, the UE is not registered with the network. The UE context in the AMF does not maintain a valid location or routing information for the UE, and thus the UE is not reachable by the AMF. However, for example, some UE context may be still stored in the UE and the AMF to prevent an authentication procedure from being performed during every registration procedure.
In the RM-DEREGISTERED state, if the UE needs to receive service that requires registration, the UE attempts to register with the selected PLMN using the initial registration procedure. Or, if the UE receives Registration Reject at initial registration, the UE remains in the RM-DEREGISTERED state. On the other hand, the UE enters the RM-REGISTERED state when receiving Registration Accept.
In the RM-DEREGISTERED state, when applicable, the AMF accepts the initial registration of the UE by sending Registration Accept to the UE and enters the RM-REGISTERED state. Or, when applicable, the AMF rejects the initial registration of the UE by sending Registration Reject to the UE.

In the RM-REGISTERED state, the UE is registered with the network. In the RM-REGISTERED state, the UE can receive service that requires registration with the network.
In the RM-REGISTERED state, if there is no tracking area identity (TAI) of a current serving cell on a list of the TAI that the UE has received from the network, the UE performs a mobility registration update procedure in order to maintain the registration of the UE and enable the AMF to page the UE. Or, the UE performs a periodic registration update procedure triggered by the expiration of a periodic update timer in order to notify the network that the UE is still in an active state. Or, the UE performs a registration update procedure in order to update its capability information or re-negotiate protocol parameters with the network. Or, when the UE needs to be no longer registered with the PLMN, the UE performs a deregistration procedure and enters the RM-DEREGISTERED state. The UE can decide to deregister from the network at any time. Or, when the UE receives a Registration Reject message or a Deregistration message or when the UE performs a local deregistration procedure without the initiation of any signaling, the UE enters the RM-DEREGISTERED state.
In the RM-REGISTERED state, when the UE needs to be no longer registered with the PLMN, the AMF performs a deregistration procedure and enters the RM-DEREGISTERED state. The AMF can decide to deregister the UE at any time. Or, after an implicit deregistration timer expires, the AMF performs implicit deregistration at any time. The AMF enters the RM-DEREGISTERED state after the implicit deregistration. Or, the AMF performs local deregistration for the UE that have negotiated to perform deregistration at an end of communication. The AMF enters the RM-DEREGISTERED state after the local deregistration. Or, when applicable, the AMF accepts or rejects the registration update from the UE. When the AMF rejects the registration update from the UE, the AMF may reject the UE registration.

Registration area management includes functions of allocating and re-allocating a registration area to the UE. The registration area is managed per the access type (i.e., 3GPP access or non-3GPP access).

When the UE is registered with the network over the 3GPP access, the AMF allocates a set of tracking area(s) (TAs) in a TAI list to the UE. When the AMF allocates the registration area (i.e., the set of the TAs in the TAI list), the AMF may consider various information (for example, mobility pattern, allowed/non-allowed area, etc.). The AMF having whole PLMN (all PLMN) as a serving area may allocate the whole PLMN as the registration area to the UE that is in a MICO mode.

The 5G system supports allocation of a TAI list including different 5G-RAT(s) in a single TAI list.

When the UE is registered with the network over the non-3GPP access, a registration area for the non-3GPP access corresponds to a unique reserved TAI value (i.e., dedicated to the non-3GPP access). Thus, there is a unique TA for the non-3GPP access to 5GC, and this is called N3GPP TAI.

The AMF includes only TAI(s) applicable to an access, to which the TAI list is transmitted, when generating the TAI list.

2) Connection Management

Connection management (CM) is used to establish and release signaling connection between the UE and the AMF. The CM includes functions of establishing and releasing signaling connection between the UE and the AMF over N1.

The signaling connection is used to enable NAS signaling exchange between the UE and a core network. The signaling connection includes both AN signaling connection for the UE between the UE and the AN and N2 connection for the UE between the AN and the AMF.

FIG. 11 illustrates a CM state model to which the present invention is applicable. More specifically, FIG. 11(a) illustrates CM state transition in the UE, and FIG. 11(a) illustrates CM state transition in the AMF.

Referring to FIG. 11, two CM states of CM-IDLE and CM-CONNECTED are used to reflect NAS signaling connection of the UE with the AMF.

The UE in a CM-IDLE state is in an RM-REGISTERED state and does not have the NAS signaling connection established with the AMF over N1. The UE performs cell selection, cell re-selection, and PLMN selection.

There are no AN signaling connection, N2 connection and N3 connection for the UE in the CM-IDLE state.
In the CM-IDLE state, if the UE is not in a MICO mode, the UE responds to paging (upon the reception) by performing a service request procedure. Or, when the UE has uplink signaling or user data to be transmitted, the UE performs the service request procedure. Or, the UE enter a CM-CONNECTED state whenever the AN signaling connection is established between the UE and the AN. Or, the transmission of an initial NAS message (registration request, service request, or deregistration request) initiates the transition from the CM-IDLE state to the CM-CONNECTED state.
In the CM-IDLE state, when the AMF has signaling or mobile-terminated data to be transmitted to the UE if the UE is not in the MICO mode, the AMF performs a network triggered service request procedure by transmitting a paging request to the corresponding UE. The AMF enter the CM-CONNECTED state whenever the N2 connection is established for the corresponding UE between the AN and the AMF.

The UE in the CM-CONNECTED state has the NAS signaling connection with the AMF over N1.

In the CM-CONNECTED state, the UE enters the CM-IDLE state whenever the AN signaling connection is released.
In the CM-CONNECTED state, the AMF enters the CM-IDLE state whenever N2 signaling connection and N3 signaling connection for the UE are released.
When a NAS signaling procedure is completed, the AMF may decide to release the NAS signaling connection of the UE. When the NAS signaling connection release is completed, the CM state in the UE is changed to the CM-IDLE state. When a N2 context release procedure is completed, the CM state for the UE in the AMF is changed to the CM-IDLE state.

The AMF can keep the UE in the CM-CONNECTED state until the UE de-registers from the core network.

The UE in the CM-CONNECTED state may be in a RRC inactive state. When the UE is in the RRC inactive state, UE reachability is managed by RAN using assistance information from the core network. When the UE is in the RRC inactive state, UE paging is managed by the RAN. When the UE is in the RRC inactive state, the UE monitors the paging using UE's CN and RAN identifier.

The RRC inactive state is applied to the NG-RAN (i.e., applied to NR and E-UTRA connected to 5G CN).

The AMF, based on network configuration, provides assistance information to the NG-RAN in order to assist the NG-RAN's decision about whether the UE transitions to the RRC Inactive state.

The RRC inactive assistance information includes a UE specific discontinuous reception (DRX) value for RAN paging in the RRC inactive state and a registration area provided to the UE.

CN assistance information is provided to a serving NG RAN node during N2 activation (i.e., during registration, service request, and path switching).

The states of the N2 and N3 reference points are not changed by the UE that enters the CM-CONNECTED state with RRC inactive. The UE in the RRC inactive state is aware of a RAN notification area.

When the UE is in the CM-CONNECTED state with the RRC inactive, the UE can resume RRC connection due to uplink data pending, a mobile initiated signaling procedure (i.e., periodic registration update), a response to RAN paging, or notifying the network that the UE has left the RAN notification area.

If the UE resumes the connection at different NG-RAN nodes within the same PLMN, the UE AS context is retrieved from an old NG-RAN node and a procedure is triggered toward the CN.

When the UE is in the CM-CONNECTED state with the RRC inactive, the UE performs cell selection to GERAN/UTRAN/EPS and follows an idle mode procedure.

The UE in the CM-CONNECTED state with the RRC inactive enters a CM-IDLE mode and follows the NAS procedure associated with the following cases.
If a RRC resume procedure fails,
If a movement of the UE to the CM-IDLE mode is required in a fail scenario that cannot be solved in the RRC inactive mode,

The NAS signaling connection management includes functions of establishing and releasing the NAS signaling connection.

The NAS signaling connection establishment function is provided by the UE and the AMF to establish the NAS signaling connection of the UE in the CM-IDLE state.

When the UE in the CM-IDLE state needs to send the NAS message, the UE initiates a service request or a registration procedure to establish signaling connection to the AMF.

Based on UE preference, UE subscription information, UE mobility pattern, and network configuration, the AMF can keep the NAS signaling connection until the UE de-registers from the network.

A procedure of the release of the NAS signaling connection is initiated by a 5G (R)AN node or the AMF.

If the UE detects that the AN signaling connection is released, the UE decides that the NAS signaling connection has been released. If the AMF detects that the N2 context has been released, the AMF decides that the NAS signaling connection has been released.

3) UE Mobility Restriction

Mobility restriction restricts the service access or mobility control of the UE in the 5G system. A mobility restriction function is provided by the UE, the RAN, and the core network.

The mobility restriction is applied to only the 3GPP access and is not applied to the non-3GPP access.

The mobility restriction in the CM-IDLE state and the CM-CONNECTED state with the RRC inactive is performed by the UE based on information received from the core network. The mobility restriction in the CM-CONNECTED state is performed by the RAN and the core network.

In the CM-CONNECTED state, the core network provides the RAN with a handover restriction list for the mobility restriction.

The mobility restriction includes RAT restriction, a forbidden area, and service area restriction as follow:
RAT restriction: RAT restriction is defined as 3GPP RAT(s) to which the access of the UE is not allowed. The UE in the restricted RAT is not allowed to initiate any communication with the network based on subscription information.
Forbidden area: in a forbidden area under predetermined RAT, the UE is not allowed to initiate any communication with the network based on subscription information.
Service area restriction: the UE defines an area that can initiate or cannot initiate communication with the network as follows:
Allowed area: in an allowed area under predetermined RAT, the UE is allowed to initiate communication with the network if allowable by subscription information.
Non-allowed area: in a non-allowed area under predetermined RAT, the service area of the UE is restricted based on subscription information. The UE and the network are not allowed to initiate session management signaling (in both the CM-IDLE state and the CM-CONNECTED state) acquiring service request or user services. The RM procedure of the UE is the same as that in the allowed area. The UE in the non-allowed area responds to the paging of the core network with service request.

In a predetermined UE, the core network determines the service area restriction based on UE subscription information. Optionally, the allowed area may be fine-tuned by the PCF (based on, for example, UE location, permanent equipment identifier (PEI), network policies, etc.). The service area restriction may be changed due to, for example, changes in the subscription information, the location, the PEI and/or the polices. The service area restriction can be updated during the registration procedure.

If the UE has the RAT restriction, the forbidden area, the allowed area, the non-allowed area, or an overlap area in a combination thereof, the UE proceeds according to the following priority:
An evaluation of the RAT restriction takes precedence over an evaluation of any other mobility restriction;
An evaluation of the forbidden area takes precedence over an evaluation of the allowed area and the non-allowed area; and
An evaluation of the non-allowed area takes precedence over an evaluation of the allowed area.

4) Mobile Initiated Connection Only (MICO) Mode

The UE may indicate a preference of an MICO mode during initial registration or registration update. The AMF determines whether the MICO mode is allowed to the UE based on local configuration, preference indicated by the UE, UE subscription information, network policies, or a combination thereof, and informs the UE of it during a registration procedure.

The UE and the core network re-initiate or exit the MICO mode in the following registration signaling. If the MICO mode is not explicitly indicated in the registration procedure and the registration procedure is successfully completed, the UE and the AMF do not use the MICO mode. Namely, the UE operates as a general UE, and the network also treats the corresponding UE as a general UE.

The AMF allocates the registration area to the UE during the registration procedure. If the AMF indicates the MICO mode to the UE, the registration area is not limited to a size of a paging area. If an AMF serving area is the whole PLMN, the AMF may provide the UE with the “whole PLMN” registration area. In this case, re-registration to the same PLMN due to the mobility does not apply. If the mobility restriction is applied to the UE of the MICO mode, the AMF allocates the allowed area/non-allowed area to the UE.

If the AMF indicates the MICO mode to the UE, the AMF regards the UE as being always unreachable while the UE is in the CM-IDLE state. The AMF rejects any request for downlink data transfer to the corresponding UE that is in the MICO mode and in the CM-IDLE state. The AMF also defers downlink transport such as SMS and location services over NAS. The UE in the MICO mode is reachable for mobile terminated data or signaling only when the UE is in the CM-CONNECTED mode.

When the UE in the MICO mode transitions to the CM-CONNECTED mode, the AMF can provide pending data indication to a RAN node to be able to immediately transfer mobile terminated data and/or signaling. If the RAN node receives this indication, the RAN node considers this information when determining user inactivity.

The UE in the MICO mode does not need to listen to paging while the UE is in the CM-IDLE state. The UE in the MICO mode can stop any AS procedure in the CM-IDLE state due to one of the following reasons until the UE initiates the transition from the CM-IDLE mode to the CM-CONNECTED mode:
if change in the UE (e.g. change in configuration) requires an update of the registration with the network
if a periodic registration timer expires
if MO data pending
if MO signaling pending

Quality of Service (QoS) Model

QoS is a technology for delivering smoothly services to the user according to properties of each of various traffics (e.g., mail, data transfer, voice, and video).

A 5G QoS model supports a QoS flow based framework. The 5G QoS model supports both QoS flows requiring a guaranteed flow bit rate (GFBR) and QoS flows not requiring the GFBR.

The QoS flow is the finest granularity of QoS differentiation in a PDU session.

A QoS flow ID (QFI) is used to identify a QoS flow in the 5G system. The QFI is unique within the PDU session. A user plane traffic with the same QFI within the PDU session receives the same traffic forwarding treatment (e.g., scheduling, admission threshold, etc.). The QFI is delivered within an encapsulation header on N3 (and N9). The QFI may be applied to PDUs (i.e., IP packets, unstructured packets, and Ethernet frames) with different types of payload.

i) Each QoS flow (guaranteed bit rate (GBR) and non-guaranteed bit rate (non-GBR)) is associated with the following QoS parameters.
5G QoS Indicator (5QI): The 5QI is a scalar that is used as a reference to 5G QoS characteristics (i.e., access node-specific parameters, for example, scheduling weights, admission thresholds, queue management thresholds, link layer protocol configuration, etc., that control QoS forwarding treatment for the QoS flow).
Allocation and Retention Priority (ARP): The ARP includes a priority level, pre-emption capability, and pre-emption vulnerability. The priority level defines the relative importance of a resource request. This is used to determine whether a new QoS flow may be accepted or needs to be rejected in case of resource limitations, and also used to determine whether an existing QoS flow pre-empts resources during resource limitations.

ii) Each GBR QoS flow is additionally associated with the following QoS parameters.
GFBR
Uplink and downlink;
Maximum Flow Bit Rate (MFBR)—uplink and downlink;
Notification control.

Two methods for controlling the following QoS flow are supported:

i) Non-GBR QoS flow with 5QI: A standardized 5QI is used as the QFI, and a normal ARP is used. In this case, when a traffic for a corresponding QoS flow starts, additional N2 signaling is not required.

ii) GBR and non-GBR QoS flows: Upon establishment of the PDU session to the QFI or establishment/modification of QoS flow, all of corresponding necessary QoS parameters, as QoS profiles, are transmitted to (R)AN and UPF.

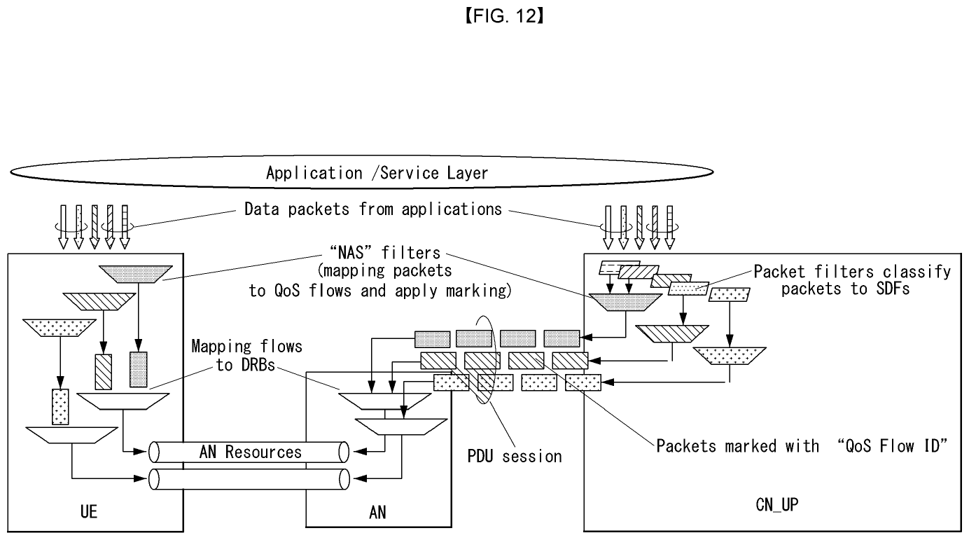

FIG. 12 illustrates classification and user plane marking for QoS flow and mapping of QoS flow to AN resources according to an embodiment of the present invention.

1) Downlink

The SMF allocates the QFI for every QoS flow. The SMF derives its QoS parameters from information provided by the PCF.

The SMF provides the (R)AN with the QFI together with a QoS profile including the QoS parameters of the QoS flow. When the PDU session or the QoS flow is established, the QoS parameters of the QoS flow, as the QoS profile, are provided to the (R)AN over N2. Further, each time NG-RAN is used, the user plane is activated. For the non-GBR QoS flow, the QoS parameters may be previously configured.

The SMF provides the UPF with a SDF template (i.e., a set of packet filters associated with a SDF received from a PCF) together with SDF precedence and the corresponding QFI, so that the UPF can perform classification and marking of downlink user plane packets.

Downlink incoming data packets are classified based on the SDF template according to the SDF precedence (without the initiation of additional N4 signaling). A CN classifies user plane traffics belonging to the QoS flow through N3 (and N9) user plane marking using the QFI. The AN binds the QoS flow to AN resources (i.e., DRB in case of 3GPP RAN). In this instance, a relation between the QoS flow and the AN resources is not limited to one-to-one correspondence.

2) Uplink

The SMF allocates a QoS rule identifier, adds a QFI of QoS flow, sets packet filter(s) to an uplink part of a SDF template, and sets QoS rule precedence to SDF precedence, thereby creating QoS rule(s) for PDU session. The SMF can provide the QoS rules to the UE so that the UE can perform classification and making.

The QoS rule includes a QoS rule identifier, the QFI of the QoS flow, one or more packet filters, and a precedence value. The same QFI (i.e., the same QoS flow) and one or more QoS rules may be associated.

A basic QoS rule is required for every PDU session. The basic QoS rule is a QoS rule of PDU session not including the packet filter (in this case, a highest precedence value (i.e., a lowest priority) is used). If the basic QoS rule does not include the packet filter, the basic QoS rule defines processing of a packet not matching with any QoS rule in the PDU session.

The UE performs classification and making of uplink user plane traffic. That is, the UE associates the uplink traffic with the QoS flow based on the QoS rule. This rule may be explicitly signaled over N1 (at the PDU session establishment or at the QoS flow establishment), or previously configured in the UE, or implicitly derived by the UE from reflective QoS.

In the UL, the UE evaluates a UL packet for the packet filter of the QoS rule based on a precedence value of the QoS rule (i.e., in increasing order of the precedence value) until the matching QoS rule (i.e., the packet filter matches with the UL packet) is found. The UE binds the UL packet to the QoS flow using the QFI in the corresponding matching QoS rule. The UE binds the QoS flow to AN resources. A.

Authorization and provisioning for vehicle to anything (V2X) communication through PC5 reference point

3GPP Release 14 V2X Work Item performs Stage 2 Normative Task. The specification of the corresponding Normative Task corresponds to TS 23.285, and this specification may be merged with 14.3.0 Version of TS 23.285. TS 23.285 describes a method of transmitting a V2X message through a PC5 reference point (or interface) by a UE. In this case, the PC5 reference point means an interface/reference point between proximity (ProSe) support UEs, which is used in control and user planes for proximity (ProSe) Direct Discovery, ProSe Direct Communication and ProSe UE versus network relay. That is, in other words, the PC5 reference point means an interface/reference point defined between UEs for V2X communication.

According to the method, a UE may be provided with mapping between V2X service corresponding to a V2X message and a Destination Layer-2 ID. The provisioning method may include a method of pre-configuring the mapping in the UE (or ME), a method of configuring the mapping in a USIM, or a method for the UE being directly provided with the mapping from a V2X control function. When the UE transmits the V2X message to the PC5 reference point based on the mapping information, the UE may configure the Destination Layer-2 ID of the corresponding V2X message as the Destination Layer-2 ID matched/mapped to the V2X service, and may transmit the V2X message.

In this specification, the V2X control function may correspond to a logical function used for a network-related operation necessary for V2X. In this specification, only one logical V2X control function is assumed to be present in each PLMN that supports V2X service. The V2X control function is used to provide a UE with parameters necessary to use V2X communication. The V2X control function is used to provide a UE with PLMN-specific parameters so that the UE can use V2X of a specific PLMN. The V2X control function is used to provide a UE with parameters necessary when the UE is “not served by an E-UTRAN.” The V2X control function may also be used for a UE to obtain a V2X user service description (USD) for receiving a V2X traffic-based MBMS through a V2X reference point from a V2X application server.

The Destination Layer-2 ID may correspond to an ID configured by a lower layer in order for a UE to receive a V2X message through the PC5. The UE has to confirm whether the Destination Layer-2 ID of each protocol data unit received through the PC5 is identical with the Destination Layer-2 ID configured in the UE. If the Destination Layer-2 IDs are identical, the UE confirms whether the type of protocol data unit provided by the lower layer with respect to a received packet is an IP packet or a non-IP packet, and delivers the corresponding protocol data unit to a corresponding higher layer entity.

Each UE has a Layer-2 ID for V2X communication through a PC5 reference point included in the source Layer-2 ID field of all frames transmitted through a layer-2 link. That is, the UE may be self-assigned the Layer-2 ID for V2X communication through the PC5 reference point. Furthermore, the UE may have a destination Layer-2 ID(s) to be used for V2X service configured therefor. The Layer-2 ID for a V2X message may be selected based on a preset configuration.

A basic principle of service authorization for V2X communication through the PC5 reference point is as follows.
A UE obtains authorization that will use V2X communication through a PC5 reference point as a PLMN unit in a serving PLMN based on the V2X control function of an HPLMN.
The V2X control function of the HPLMN requests right information from the V2X control function of a serving PLMN.
The V2X control function within the HPLMN merges Home and the authorization information from the serving PLMN, and notifies the UE of the final authorization information.
A visited PLMN (VPLMN) or the V2X control function of the HPLMN may cancel the approval anytime. When the right is cancelled by the VPLMN, the V2X control function of the HPLMN must be notified of the cancellation.

The following information may be provided to the UE for V2X communication through the PC5 reference point.

1) Authorization Policy:
When a UE is “served by an E-UTRAN”: a PLMN on which the UE is authorized to perform V2X communication through a PC5 reference point.
When a UE is “not served by an E-UTRAN”: “when it is not provided with service by an E-UTRAN”, it indicates whether the UE has the right to perform V2X communication through a PC5 reference point.

2) Radio Parameters when a UE is “not Served by an E-UTRAN”:
They include radio parameters along with a geographical area that needs to be configured in the UE so that the UE can perform V2X communication through the PC5 reference point when the UE is “not served by the E-UTRAN.” Such radio parameters (e.g., frequency band) may be defined in TS 36.331 [9] (i.e., TS 36.300). The UE uses the radio parameters only when it can locate itself in the corresponding geographical area. If not, the transmission of the UE is not permitted.

3) Policy/Parameter Through V2X Communication Through PC5 Reference Point:
Mapping (e.g., particular provider service identifier (PSID) or intelligent transport systems (ITS)-application object identifier (AID)(s) of a V2X application) of a Destination Layer-2 ID and V2X services.

A PLMN operator may adjust the Destination Layer-2 IDs of different V2X services so that they are configured in a consistent manner.

Additional information may be provided to a UE for using V2X communication (e.g., for unicast or MBMS) through an LTE-Uu reference point.

The following information may be selectively provided to a UE for V2X communication through an LTE-Uu reference point.

1) A PLMN on which a UE has the Right to Use MBMS-Based V2X Communication
A corresponding user service description (USD) for receiving MBMS-based V2X traffic from the PLMN. The USD may be obtained through the V2 reference point of a V2X application server.

2) V2X Application Server Address Information
Fully qualified domain names (FQDN) or an Internet protocol (IP) address list of the V2X application server associated with a PLMN list to which provided geographical area information and configuration are applied

3) Selective Configuration for V2X Application Server Discovery that Uses an MBMS
A PLMN that receives V2X Application Server information through the MBMS and a corresponding USD list

The PC5 reference point defined in TS 23.303 [5] is used for the transmission and reception of a V2X message. V2X communication through the PC5 reference point supports a roaming and inter-PLMN operation. V2X communication through the PC5 reference point is supported when a UE is “served by an E-UTRAN” and when a UE is “not served by an E-UTRAN.”

The UE may be approved to transmit and receive V2X messages by the V2X control function of an HPLMN.

V2X communication through the PC5 reference point may correspond to a proximity (ProSe) direct communication type having the following characteristics:
V2X communication through the PC5 reference point is connectionless and has no signaling through a PC5 control plane for a connection configuration.
V2X messages are exchanged between UEs through a PC5 user plane.
Both IP-based and non-IP-based V2X messages are supported.
In the case of the IP-based V2X message, only IPv6 is used and IPv4 may not be supported.

An identity/ID used for V2X communication through the PC5 reference point is described later.

Each UE has a Layer-2 ID for V2X communication through the PC5 reference point included in the source layer-2 ID fields of all frames transmitted through the Layer-2 link. The UE is self-assigned the Layer-2 ID for V2X communication through the PC5 reference point.

When an IP-based V2X message is supported, a UE may automatically configure a link local IPv6 address as a source IP address as defined in Paragraph 4.5.3 of TS 23.303 [5].

A source Layer-2 ID needs to be changed for each time in order to guarantee that the source Layer-2 ID cannot be tracked or identified by other vehicle for a short time or more required by an application.

In the case of IP-based V2X communication through a PC5 reference point, a source IP address may be changed or not over time.

A UE may have a Destination Layer-2 ID(s) to be used for V2X service configured therefor. The Layer-2 ID of a V2X message is selected based on the configuration as described above.

Receive-Only Mode

A receive-only mode (broadcast-dedicated service for a UE not having PLMN broadcast subscription) UE means a UE which can receive only an MBMS, but cannot perform UL transmission to a network. In relation to the receive-only mode UE, TR 23.746 document and TS 23.246 document 14.1.0 version may be merged with this specification.

A UE configured in the receive-only mode may receive only an MBMS broadcast service over an E-UTRAN without the need to access a PLMN that provides the MBMS service and to register it with the PLMN. A UE configured to operate in the receive-only mode needs to camp on a network cell of an evolved MBMS (eMBMS) broadcast carrier, and needs to attempt the reception of MBMS service based on only a temporary mobile group identity (TMGI) value range standardized for the receive-only mode. The UE should not attempt to receive the MBMS service with respect to a TMGI out of the standardized TMGI range. The UE should refrain from mobile management or other signal for a network that provides an MBMS. The UE receives MBMS broadcast using obtained system information. The use of the receive-only mode does not require a USIM for the UE.

A UE may have the receive-only mode configured therefor as independent unicast using EPS bearer context. Such a configuration option enables the UE to operate in the receive-only mode (as defined above) for MBMS broadcast service, and independently follows a regular NAS/RRC procedure for unicast service along with a PLMN. Such an operation mode requires USIM and PLMN subscription in order to receive unicast service. Additional subscription or qualification credential for receiving the MBMS broadcast service is not necessary.

A given device having an MBMS broadcast receiver and configured to operate in the receive-only mode has the following characteristics and may receive broadcast content:
PLMN qualification credential/subscription is not necessary unless an EPS unicast bearer is necessary for a device.
A UE may access only broadcast service that does not require subscription without PLMN credential/subscription. Content may be free to air (FTA) content as defined in TS 22.101 [2]. In this case, the content may be viewed even without content subscription.
A UE does not need to support the uplink.

This may be performed although content protection processed in the application layer is present. In this case, security is provided in the application layer, and a key, etc. is provided out of band.

A UE may have all types of information necessary for the UE pre-configured therefor in order to obtain system information and to receive MBMS service. The information includes the following information.
A PLMN ID(s) providing MBMS service
ATMGI(s):
In the case of a network that provides MBMS service in the MBMS transmission-only mode, the TMGI(s) of each MBMS service needs to be configured in a UE.
The UE may be configured to receive a TMGI(s) through service announcement.
RAN-specific information and/or
A USD(s)

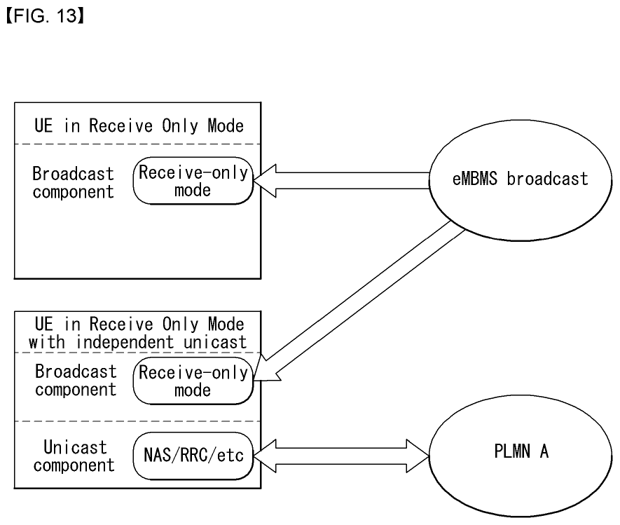

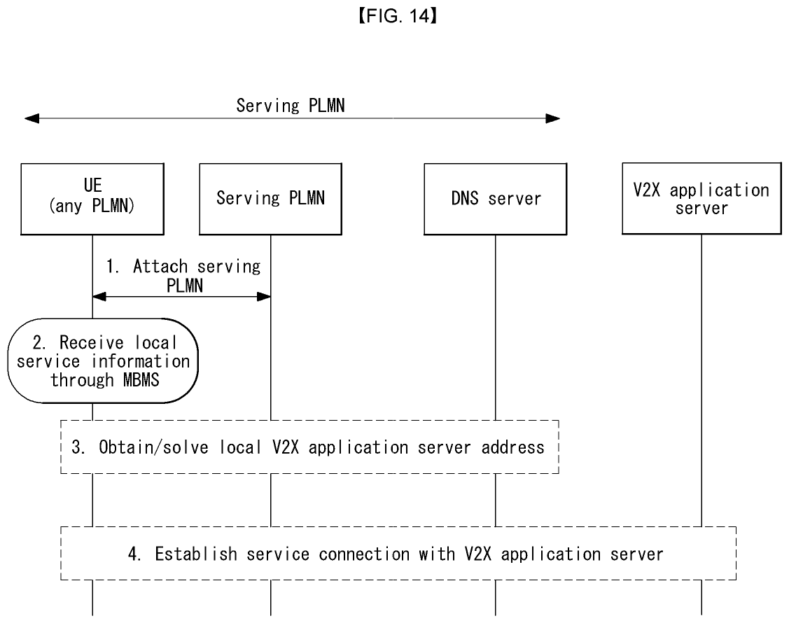

FIG. 13 illustrates the UE component of a receive-only mode with independent unicast according to an embodiment of the present invention.

Referring to FIG. 13, the unicast component is activated only in the receive-only mode with independent unicast. The unicast component follows a regular NAS/RRC procedure for an E-UTRAN/EPC in order to receive unicast service.

In the case of a broadcast component, an MBMS radio resource for TV service not having PLMN subscription is configured in a UE. The broadcast component of the UE needs to camp on a network cell of an eMBMS broadcast carrier, and needs to attempt the reception of MBMS service based on a standardized TMGI value range only. The UE should not attempt to receive MBMS service with respect to a TMGI out of the standardized TMGI range. The broadcast component should refrain from signaling over a network that provides mobility management or MBMS. The broadcast component uses system information obtained to receive MBMS broadcast.

FIG. 14 illustrates a V2X application server information reception procedure through an MBMS according to an embodiment of the present invention.

1. A UE accesses a serving PLMN (if it has not accessed the serving PLMN) when it wants V2X communication through an LTE-Uu.

2. If the UE has a configuration to receive V2X application server information through MBMS, it may receive local service information through a corresponding broadcast traffic channel. The local service information includes address information of a local V2X application server (e.g., FQDN(s) of the server). Furthermore, if MBMS downlink is used, the local service information may include a USD for a corresponding V2X application server. In this case, the UE may be an MBMS receive-only mode for obtaining the local service information.

3. The UE obtains a local V2X application server address based on the information received in Step 2 (e.g., through DNS query for the received FQDN).

4. The UE may establish a connection with a V2X application server for the service. The UE obtains a USD is obtained if the UE is not provided to receive a V2X message through the MBMS in Step 2.

Road side unit (RSU)

The followings are described in TS 22.185 and TS 23.285 with respect to the RSU.

The RSU is a stationary infra entity that supports a V2X application, and may exchange messages with other entity that supports the V2X application. The RSU corresponds to a logical entity in which V2X application logic has been combined with the function of an eNB (also called an eNB-type RSU) or a UE (also called an UE-type RSU).

V2X communication may include two types of operation modes, including an operation mode through the PC5 and an operation mode through an LTE-Uu. The LTE-Uu may be unicast and/or MBMS. The two operation modes may be independently used by a UE for transmission and reception. For example, the UE does not use the LTE-Uu for transmission, but may use it for the reception of the MBMS. The UE may also receive a V2X message through an LTE-Uu unicast downlink.

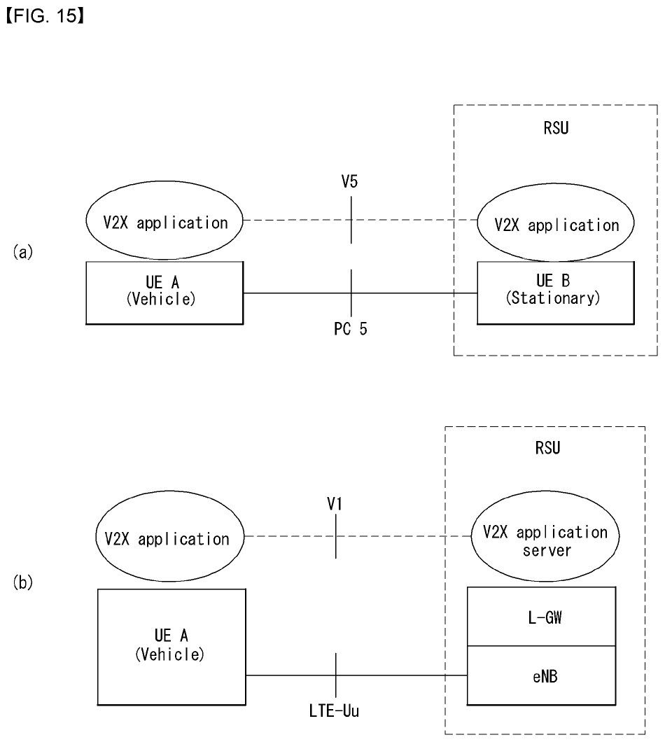

The following principle may be applied to both the operation modes.
V2X application servers (of different domains) may exchange V2X messages through communication.
A ProSe discovery function (TS 23.303 [5] Paragraph 5.3 ProSe Direct Discovery) does not require V2X service. The ProSe discovery function may be used in a V2X support UE, but depends on a UE implementation.
Legal block requirements are applied to V2X service according to regional regulations.
The RSU corresponds to an implementation option not an architecture entity. This may be achieved if the V2X application logic/server is deployed along with some entities of a 3GPP system as in the example of FIG. 15 to be described later.

FIG. 15 illustrates a method of implementing an RSU, which may be applied to the present invention. Specifically, FIG. 15(a) illustrates an RSU of a UE type in which a UE and V2X application logic have been combined, and FIG. 15(b) illustrates an RSU of an eNB type.

Referring to FIGS. 15(a) and 15(b), the RSU may receive a V2X message through an SGi, PC5 or LTE-Uu interface according to an implementation option.

In the example of FIG. 15(b), the RSU may be configured with an eNB, a collocated L-GW and a V2X application server.

V2X Authorization Procedure

The V2X authorization procedure enables a UE to search a V2X control function for a V2X communication parameter.

The UE initiates the V2X authorization procedure when the following condition is established:

a) If the UE has been requested by a lower layer to transmit or receive the V2X message of V2X service identified by a V2X service identity using V2X communication through the PC5:

1) The valid period expiration time of configuration parameters for the V2X communication through the PC5 indicates a previous time not a current time; or

2) A V2X service identity has not been registered with the entry of a V2X service list approved for V2X communication through the PC5. A registered PLMN has been registered with a PLMN list on which a UE has the right to use V2X communication through the PC5;

b) If the UE is served by an E-UTRAN and the UE changes a registered PLMN to a PLMN not present in a PLMN list on which the UE has the right to use V2X communication through the PC5 when the UE is served by the E-UTRAN;

c) If the UE is served by an E-UTRAN and the UE changes a registered PLMN to a PLMN not present in a list of PLMNs approved to use V2X communication through an LTE-Uu;

d) If the UE receives a request to transmit or receive the V2X message of V2X service not identified by a V2X service identity using V2X communication through the LTE-Uu from a lower layer and the valid period expiration of a configuration parameter for V2X communication through the LTE-Uu indicates a previous time not a current time; or

e) If the UE has been requested by a lower layer to transmit or receive a V2X message using V2X communication through the LTE-Uu of V2X service identified by a V2X service identity:

1) The valid period expiration time of a configuration parameter for the V2X communication through the LTE-Uu indicates a previous time not a current time; or

2) A V2X service identity is not included in the list entry of V2X services authorized for the V2X communication through the LTE-Uu, and a registered PLMN is in a list of PLMNs on which a UE is permit to use the V2X communication through the LTE-Uu.

If the parameters of a PDN connection for communication with a V2X control function have been configured:

a) If the PDN connection according to the parameters has not yet been established, a UE needs to establish the PDN connection according to the parameters; and

b) If the PDN connection according to the parameters (due to the application of the specification or other applications) has already been established, a UE needs to transmit and receive the messages of a V2X authorization procedure through the PDN connection established according to the parameters.

The UE needs to transmit the message of the V2X authorization procedure to a discovered V2X control function IP address.

In order to start a V2X authorization procedure, a UE needs to request the client-initiated provisioning of the management object specified in 3GPP TS 24.385 [3].

When the client-initiated provisioning request of the management object specified in 3GPP TS 24.385 [3] is received, the V2X control function may update a management object designed in 3GPP TS 24.385 [3] in the UE.

When the client-initiated provisioning of the management object specified in 3GPP TS 24.385 [3] is successfully completed, the UE and the V2X control function should consider the V2X authorization procedure to have been successfully completed.

If the UE does not receive a response within an implementation-dependent time after it transmits a request for the client-initiated provisioning of the management object specified in 3GPP TS 24.385 [3], the UE determines that the V2X authorization procedure has not been successfully completed.

Method of Obtaining V2X Service and Mapping Information of Destination Layer-2 ID

As described above, when a UE transmits a V2X message through a PC5 reference point, it configures a Destination Layer-2 ID mapped to V2X service and transmits the V2X message. However, if the UE attempts to transmit a V2X message for a V2X service that has not been previously provided (e.g., V2X service provided by a newly installed V2X application), how the UE will configure the Destination Layer-2 ID and transmit the V2X message has not yet been discussed specifically.

According to a conventional operation, when a UE attempts to transmit a V2X message for a V2X service that has not been previously provided, it cannot transmit the V2X message because there is no information provided for the corresponding V2X service.

In such a situation, the UE may perform an operation for obtaining Destination Layer-2 ID information mapped to the corresponding V2X service in the case of in-coverage and out-of-coverage (OOC). In the case of the in-coverage, the UE may obtain Destination Layer-2 ID information mapped to a corresponding V2X service by requesting (e.g., service authorization request) it from a V2X control function through a V3 reference point. In this case, the V3 reference point means an interface/reference point defined between the UE and the V2X control function for V2X authorization. In the case of the out-of-coverage (OOC), the UE cannot obtain Destination Layer-2 ID information mapped to corresponding V2X service there is no method of being connected to the V2X control function.

Furthermore, a receive-only mode UE cannot be connected to a network. Although the receive-only mode UE is in-coverage, it cannot obtain mapping information with a Destination Layer-2 ID for a corresponding V2X service as in the case of the OOC.

Moreover, a method for a UE or receive-only mode UE within the above-described OOC to transmit a V2X message for a V2X service that has not been previously provided through a PC5 reference point is not now present.

For example, a case may be assumed where a V2X service has been newly implemented for road safety in a country or area where the V2X service has not been implemented. In this case, if a corresponding UE has no capability to connect to a network or cannot connect to the network although a V2X application providing the corresponding V2X service has been implemented in the UE, there is a problem in that the UE cannot be provided with a specific V2X service because it cannot transmit a V2X message for the installed V2X application.

For another example, a case may be assumed where Destination Layer-2 ID information mapped to a V2X service is not provided to a UE because information on the V2X service implemented in a specific country or area has not been updated in an HPLMN to which the UE has subscribed. Thereafter, if the HPLMN of the UE has been updated with the corresponding information on V2X service, but the UE has not been provided with update contents/information because the UE is not connected to the network, although a V2X application providing the V2X service is installed in the UE, the UE cannot be provided with the V2X service (e.g., road safety service) because the UE cannot transmit a V2X message.

What a UE configured with a Default layer-2 ID transmits a V2X message including the Default layer-2 ID (considering that a V2X service has been mapped to the Default layer-2 ID) when the V2X service not having mapping information with a Destination Layer-2 ID is received is recently discussed (refer to TS 24.386 v.14.1.0 document, the corresponding document may be merged with this specification). However, if such an operation of a UE is defined, when a V2X service is received regardless of whether the V2X service has been approved, the UE has to periodically transmit a V2X message using a PC5 resource (with respect to an unapproved V2X service). Accordingly, there is a problem in that PC5 resource waste is great. Furthermore, if such an operation of a UE is defined, there is a problem in that a network does not recognize a V2X service now used by the UE.

Accordingly, this specification proposes various embodiments for solving the above-described problem and providing a UE with Destination layer-2 ID information mapped to a V2X service so that PC5 resource and V2X service management by a network are possible.

This specification proposes a method capable of receiving corresponding provisioning information if a UE tries to transmit a V2X message for a V2X service that has not been previously provided (e.g., when a new V2X application is installed), but cannot receive provisioning information on the corresponding V2X service over a network because the UE cannot connect to the network. In this case, the provisioning information may include mapping information between, specifically, V2X services (e.g., PSID or ITS-AID(s) of the V2X application) and Destination layer-2 ID(s). In addition, the provisioning information may additionally include various types of information for the V2X service (e.g., area information where the V2X service can be used and valid period of the V2X service).

In this case, the reason why the UE cannot connect to the network may correspond to one of the followings. However, the reason is not limited thereto, and the UE may not be connected to the network due to various reasons in addition to reasons described hereinafter. In this specification, if a UE cannot connect to a network, this may mean that the UE cannot be connected to the V2X control function within the HPLMN of the UE.
When the UE is positioned in out-of-coverage (OOC) and/or
When the UE is the receive-only mode UE.

A UE described later in the following proposal embodiments refers to a “UE that cannot be connected to a network” for the above-described reasons although it is not redundantly described. Furthermore, it is assumed that an RSU or other UE described later in the following proposal embodiments can connect to a network.

[Proposal 1] UE-Initiated Method

1. First, a UE may request mapping information on V2X service from an RSU or other UE through a PC5 message (message transmitted through a PC5 reference point). In this case, the mapping information may correspond to the above-described provisioning information, and may include information on V2X services (e.g., PSID or ITS-AID(s) of a V2X application) and mapping information between Destination layer-2 ID(s). In addition, the mapping information may additionally include various types of information on the V2X services (e.g., area information where the V2X services may be used and the valid period the V2X services).

2. The RSU or other UE that has received the request for the mapping information from the UE may perform one of the following operations.

A. Method for RSU or other UE to directly respond

i. If information on V2X service (e.g., V2X service identity information) is included in the PC5 message transmitted by the UE, the RSU or other UE that has received the PC5 message may confirm whether it has had/stored the information on V2X service (V2X service identity) included in the PC5 message. The RSU or other UE basically stores a Destination Layer-2 ID mapped to V2X service information along with the V2X service information. Accordingly, the RSU or other UE may confirm whether mapping information on V2X service information has been previously stored by confirming whether the corresponding V2X service information has been previously stored.

If it is confirmed that the RSU or other UE has had/stored the information on V2X service, the RSU or other UE may generate a PC5 response message including mapping information (i.e., Destination layer-2 ID(s) information mapped to the V2X service) on the V2X service information, and may respond to the PC5 message of the UE by transmitting the PC5 response message. If it is confirmed that the RSU or other UE has not had/stored the information on V2X service, however, the RSU or other UE may obtain the mapping information through “Method for RSU or other UE to request V2X control function” of Step B to be described later, and may respond to the PC5 message of the UE by including the obtained mapping information in a PC5 response message.

ii. If information on V2X service (e.g., V2X service identity information) is not included in the PC5 message transmitted by the UE, the RSU or other UE that has received the PC5 message may generate a PC5 response message including all types of their mapping information, and may respond to the PC5 message transmitted by the UE by transmitting the PC5 response message. If information on desired V2X service is not present in the mapping information included in the received PC5 response message, the UE may include information on V2X service through which the UE wants to obtain the mapping information in a PC5 message as in the i) and request the information on V2X service from the RSU or other UE again and/or may transmit a PC5 message, specifying that desired mapping information is not present in a transmitted PC5 response message, to the RSU or other UE again. The RSU or other UE that has received the PC5 message may obtain the mapping information through “Method for RSU or other UE to request V2X control function” of Step B to be described later, and may respond to the PC5 message of the UE by including the obtained mapping information in a PC5 response message.

B. Method for RSU or other UE to request V2X control function: When the RSU or other UE receives the PC5 message to request the mapping information from the UE, it may transmit the corresponding request to a V2X control function through a V3 reference point. In this case, a conventional message used when service is granted may be used as the transmitted request message. When the RSU or other UE receives the mapping information from the V2X control function, it may transmit the mapping information to the UE (through the PC5 response message).

i. If information on V2X service (e.g., V2X service identity information) is included in the PC5 message transmitted by the UE, the RSU or other UE that has received the PC5 message may confirm whether it has had/stored the information on V2X service (V2X service identity) included in the PC5 message.

If it is confirmed that the RSU or other UE has had/stored the information on V2X service, the RSU or other UE may generate a request message including mapping information on the V2X service information (i.e., Destination layer-2 ID(s) information mapped to the V2X service), and may transmit the request message to a V2X control function through a V3 reference point. The V2X control function that has received the request message may generate a response message including mapping information on the V2X service information (i.e., Destination layer-2 ID(s) information mapped to the V2X service) included in the request message, and may respond to the request message by transmitting the response message.

The reason why the RSU or other UE separately transmits the request message to the V2X control function although it has already had/stored the information on V2X service as described above is to have an object of i) obtaining up-to-date mapping information, ii) confirm the validity of a UE that has requested the mapping information and/or iii) validity double check/confirm. More specifically, in relation to the i), the V2X control function may update mapping information on V2X service information in real time. Accordingly, the RSU or other UE needs to update the mapping information with up-to-date mapping information and provide the update mapping information to the UE. Accordingly, in order to provide the up-to-date mapping information to the UE, the RSU or other UE may additionally request the mapping information from the V2X control function although it has already had/stored the information on V2X service. Furthermore, in relation to the ii) and iii), the V2X control function needs to selectively provide the mapping information to a UE having the right to access the mapping information on V2X service information from a security viewpoint. Accordingly, the RSU or other UE may transmit a request message for confirming whether the UE that has requested the mapping information is a valid UE having the right to obtain the mapping information. In this case, the request message (i.e., V3 message) may include identification information (e.g., application ID or IMSI) on the corresponding UE. The V2X control function may identify the UE that has requested the mapping information and confirm whether the corresponding UE is a valid UE having the right to obtain the mapping information based on the identification information included in the received request message.

Alternatively, in another embodiment, if it is confirmed that the RSU or other UE has had/stored the information on V2X service, the RSU or other UE may directly generate a response message including mapping information on the V2X service information, and may transmit the response message as a response to the PC5 message transmitted by the UE. In this case, the RSU or other UE that has had/stored the information on V2X service may correspond to an entity that has been previously approved/configured by a network to provide mapping information to a corresponding UE. In contrast, if it is confirmed that the RSU or the UE has not had/stored the information on V2X service, the RSU or the UE may generate a request message to request mapping information on the V2X service information and transmit the request message to the V2X control function through a V3 reference point. The V2X control function that has received the request message may generate a response message including mapping information on the corresponding V2X service information (i.e., Destination layer-2 ID(s) information mapped to the V2X service), and may respond to the request message by transmitting the response message.

ii. If information on V2X service (e.g., V2X service identity information) is not received in the PC5 message transmitted by the UE, the RSU or other UE may transmit a request message (to request the mapping information) to the V2X control function through a V3 reference point. The V2X control function that has received the request message may generate a response message including all types of their mapping information, and may respond to the request message by transmitting the response message to the RSU or other UE. In this case, the transmitted response message may correspond to a V3 message. In this case, the request message may also be transmitted for the objects of the ii) and iii). In this case, the request message may include identification information (e.g., application ID or IMSI) on the UE. The V2X control function may identify the UE that has requested the mapping information and confirm whether the corresponding UE is a valid UE having the right to obtain the mapping information based on the identification information included in the received request message.

3. Additionally/selectively, the RSU or other UE may transmit the mapping information through a PC5 message for a predetermined time and/or in a preset period for UEs that require the mapping information. The predetermined time and the preset period information may be transmitted to the RSU or other UE along with the mapping information or may have been pre-configured in the RSU or other UE.

If at least one of the following conditions is satisfied, the RSU or other UE may perform Step 3. by omitting Steps 1. and 2.

1) When the RSU or other UE receive the mapping information from a different RSU and/or UEs

2) If the RSU or other UE does not have information on a Destination Layer-2 ID transmitted by a different RSU or UEs:

A) The RSU or other UE may request information on the received Destination Layer-2 ID to the V2X control function through a V3 reference point.

B) The V2X control function may respond to the request as a response message including a V2X service identity mapped to the received Destination Layer-2 ID.

C) The RSU or other UE may generate/store mapping information on the mapping relation between the V2X service identity received from the V2X control function through the response message and a Destination Layer-2 ID transmitted by a different RSU or UEs. Furthermore, the RSU or other UE may transmit the corresponding mapping information through a PC5 message for a predetermined time and/or in a preset period. The RSU or other UE may receive information on the predetermined time and the preset period from the V2X control function or the information may have been pre-configured in the RSU or other UE.

That is, when the RSU or other UE receives the mapping information from a different RSU and/or UEs and/or receives Destination Layer-2 ID information, it may transmit the mapping information through a PC5 message for the predetermined time and/or in the preset period.

As described above, the operation for the RSU or other UE to directly request the mapping information from the V2X control function, as described above, may be newly added as a V2X authorization procedure-initiating condition because it may be performed through a V2X authorization procedure (or a message used in the V2X authorization procedure). That is, a case where the RSU or other UE i) has received a request for the transmission of mapping information from the UE, but does not have the corresponding information, a case where the RSU or other UE ii) has received a Destination Layer-2 ID from a different RSU or UEs, but has no V2X service information mapped thereto, etc. may be included as a detailed V2X authorization procedure-initiating condition. If the corresponding condition is satisfied/established, the RSU or other UE may request the mapping information from the V2X control function through the initiated V2X authorization procedure, and may deliver/transmit the mapping information, received from the V2X control function, to a UE that has requested the corresponding mapping information.

If an RSU or other UE requests mapping information from a V2X control function using the authorization procedure as described above, there are effects in that the RSU or other UE can properly update up-to-date information in real time compared to a case where a UE solely operates and security is further enhanced due to validity check to confirm whether a UE is a UE capable of providing the mapping information. Furthermore, there is an effect in that synchronization between UE and network operations is properly maintained because the UE does not solely operate, but operates under the approval/confirmation of the network.

[Proposal 2] Network or RSU-Initiated Method

An RSU may transmit mapping information between a new V2X service (information) and a Destination Layer-2 ID through a PC5 message for a predetermined time and/or periodically. Such an operation of the RSU may be triggered by a V2X application server or a V2X control function. A case where the operation is triggered by the V2X control function may be subdivided into a case where the operation is triggered by the V2X control function of the HPLMN of a UE and a case where the operation is triggered by the V2X control function of a different PLMN (not by the HPLMN).

A detailed operation of an embodiment in which the V2X application server triggers the periodical transmission of mapping information is as follows.

A. The V2X application server may transmit a request message, indicating that the update of a new V2X service is necessary, to the V2X control function through a V2 interface.

B. The V2X control function that has received the request message may configure the V2X service identity of the requested new V2X service, and may configure a Destination Layer-2 ID mapped to the V2X service identity. Furthermore, the V2X control function may configure/store mapping information between the V2X service identity and the mapped Destination Layer-2 ID.

C. The newly configured/stored mapping information may be delivered to a UE through one of the following methods (i. and ii.).

i. Delivery method through PC5 reference point: the V2X control function may deliver the mapping information to an RSU or other UEs through a V3 reference point. In this case, a transmission time and/or a transmission period may also be delivered along with the mapping information. The RSU or other UEs that have received them transmit the mapping information through a PC5 reference point at the delivered transmission time and/or transmission period.

ii. MBMS delivery method: the V2X control function may deliver the mapping information to a V2X application server through a V2 reference point. In this case, a transmission time and/or a transmission period may also be delivered along with the mapping information. The V2X application server that has received the corresponding information (i.e., the mapping information and information at the transmission time and/or transmission period) may deliver the corresponding information to a broadcast multicast-service center (BM-SC) through an MB2 reference point. Furthermore, the corresponding information may be delivered to an E-UTRAN through an MBMS-gateway (GW), and the E-UTRAN may broadcast the corresponding information again through an MBMS carrier. In this case, the E-UTRAN may broadcast the mapping information, the transmission time and/or the transmission period at the received transmission time and/or in the transmission period. The RSU or other UE that has received the corresponding information (i.e., the mapping information and the information at the transmission time and/or the transmission period) may transmit the mapping information to the UE (through a PC5 message) at the received transmission time and/or in the transmission period.

A detailed operation regarding an embodiment in which the V2X control of a different PLMN (hereinafter referred to as a “different V2X control function”) not the HPLMN of a UE triggers the periodical transmission of mapping information is as follows.

A. A different V2X control function may deliver a request message, indicating that the update of a new V2X service is necessary, to the V2X control function of an HPLMN through a V6 interface. In this case, a Destination Layer-2 ID mapped to the corresponding V2X service may be included in the request message or not.

B. The V2X control function that has received the request message may configure the V2X service identity of the requested new V2X service, and may configure a Destination Layer-2 ID if the Destination Layer-2 ID mapped to the V2X service identity is not present. Furthermore, the V2X control function may configure/store mapping information between the V2X service identity and the mapped Destination Layer-2 ID.

C. The method described in Step C. (i. Delivery method through PC5 reference point, ii. MBMS delivery method) may be identically applied to a method of delivering new mapping information to a UE, and a redundant description thereof is omitted.

The method described in Step C. (i. Delivery method through PC5 reference point, ii. MBMS delivery method) may be identically applied to a detailed operation regarding an embodiment in which the V2X control function of the HPLMN of a UE triggers the periodical transmission of mapping information.

That is, if it is determined that the update of a new V2X service is necessary, the V2X control function may configure the V2X service identity of the new V2X service, and may configure a Destination Layer-2 ID if the Destination Layer-2 ID mapped to the V2X service identity is not present. Furthermore, the V2X control function may configure/store mapping information between the V2X service identity and the mapped Destination Layer-2 ID. The V2X control function delivers the configured/stored mapping information to a UE through Step C. (i. Delivery method through PC5 reference point, ii. MBMS delivery method).

FIG. 16 is a flowchart regarding a method for a first UE to support the V2X communication of a second UE according to an embodiment of the present invention. In relation to this flowchart, the above-described embodiments may be applied identically and similarly, and a redundant description thereof is omitted. Furthermore, in this flowchart, the first UE may correspond to the above-described RSU or other UE.

First, the first UE may receive, from the second UE, a first request message that requests mapping information on V2X service (S1610). In this case, the mapping information may include a Destination Layer-2 ID mapped to the V2X service. More specifically, the mapping information may include information (e.g., PSID or ITS-AID(s) of a V2X application) on the V2X services and mapping information between Destination layer-2 ID(s). In addition, the mapping information may additionally include various types of information (e.g., area information where the V2X services may be used and the valid period the V2X services) on the V2X service. The Destination Layer-2 ID may correspond to an identifier for identifying a protocol data unit, provided with respect to the V2X service, by the second UE. Furthermore, in this case, the second UE may correspond to a receive-only mode UE or a UE positioned in out-of-coverage (OOC).

Next, the first UE may transmit a second request message, requesting the mapping information, to a V2X control function (S1620). The second request message may be a message used in a V2X authorization procedure for searching the V2X control function for a V2X communication parameter. In this case, the reception of the first request message may be configured as a condition in which the first UE initiates a V2X authorization procedure. Furthermore, identification information (e.g., application ID or IMSI) on the second UE may have been included n the second request message.

Next, the first UE may receive a second response message, including the mapping information, from the V2X control function as a response to the second request message (S1630).

Next, the first UE may generate a first response message including the received mapping information, and may transmit the first response message to the second UE as a response to the first request message (S1640). The first request message and the first response message are transmitted through a PC5 reference point. The second request message and the second response message may be transmitted through a V3 reference point. In this case, the PC5 reference point corresponds to a reference point defined between the UEs for V2X communication. The V3 reference point may correspond to a reference point defined between the UE and the V2X control function for V2X authorization.

Although not shown in this flowchart, the first UE that has obtained or previously stored mapping information may transmit the mapping information to a different UE (e.g., a third UE) at a predetermined time and/or in a preset period. In this case, information on the predetermined time and/or the preset period may be received by the first UE through the second response message.

General Apparatus to which the Present Invention May be Applied

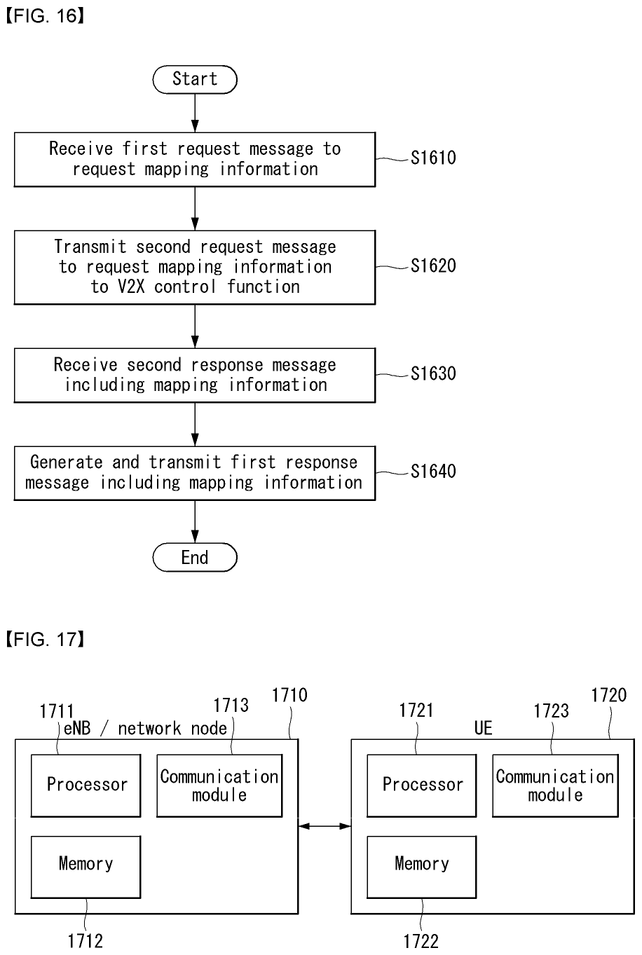

FIG. 17 illustrates a block diagram of a communication apparatus according to an embodiment of the present invention.

Referring to FIG. 17, the wireless communication system includes a network node 1710 and multiple UEs 1720. The apparatus shown in this figure may be implemented to perform at least one of the above-described network/UE functions and may be implemented to integrate and perform one or more functions.

The network node 1710 includes a processor 1711, memory 1712 and a communication module 1713.

The processor 1711 implements at least one function, process, method proposed in FIGS. 1 to 16 and/or the function, process and/or method proposed in this document. Furthermore, a module, program, etc. implementing the function, process and/or method proposed in this specification may be stored in the memory 1712 and may be executed by the processor 1711.

The layers of a wired/wireless interface protocol may be implemented by the processor 1711. Furthermore, the processor 1711 may be implemented so that the contents described in various embodiments proposed in this document are independently applied or two or more of the embodiments are applied at the same time.

The memory 1712 is connected to the processor 1711 and stores various types of information for driving the processor 1711. The memory 1712 may be positioned inside or outside the processor 1711, and may be connected to the processor 1711 by various well-known means.

The communication module 1713 is connected to the processor 1711 and transmits and/or receives a wired/wireless signal. The network node 1710 may include a base station, an MME, an HSS, an SGW, a PGW, an SCEF, an SCS/AS, an AUSF, an AMF, a PCF, an SMF, a UDM, a UPF, an AF, an (R)AN, a UE, an NEF, an NRF, a UDSF and/or an SDSF, for example. Specifically, if the network node 1710 is a base station (or if the network node is implemented to perform an (R)AN function), the communication module 1713 may include a radio frequency (RF) unit for transmitting/receiving radio signals. In this case, the network node 1710 may have a single antenna or multiple antennas.

The UE 1720 includes a processor 1721, memory 1722 and a communication module (or RF unit) 1723. The processor 1721 implements at least one function, process, method proposed in FIGS. 1 to 16 and/or the function, process and/or method proposed in this document. Furthermore, a module, program, etc. implementing the function, process and/or method proposed in this document may be stored in the memory, and may be executed by the processor 1721.

The layers of a wired/wireless interface protocol may be implemented by the processor 1721. Furthermore, the processor 1721 may be implemented so that the contents described in various embodiments proposed in this document are independently applied or two or more of the embodiments are applied at the same time.

The memory 1722 is connected to the processor 1721 and stores various types of information for driving the processor 1721. The memory 1722 may be positioned inside or outside the processor 1721, and may be connected to the processor 1721 by various well-known means. The communication module 1723 is connected to the processor 1721 and transmits and/or receives a wired/wireless signal.

The memory 1712, 1722 may be positioned inside or outside the processor 1711, 1721 and may be connected to the processor 1711, 1721 by various well-known means. Furthermore, the network node 1710 (in the case of a base station) and/or the UE 1720 may have a single antenna or multiple antennas.

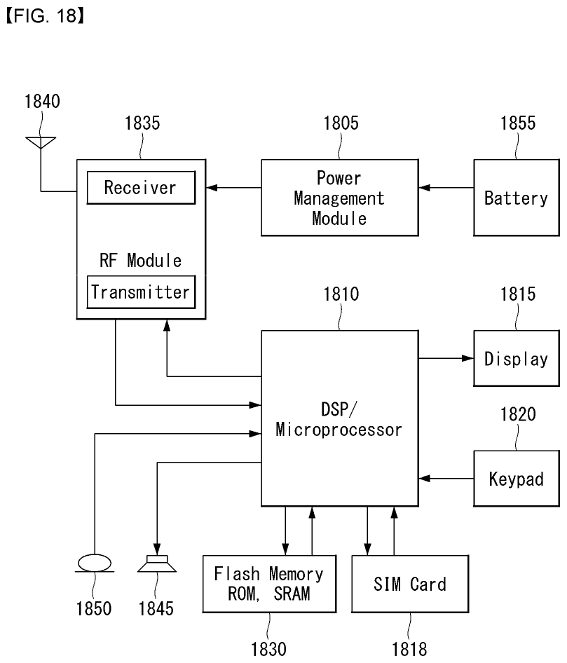

FIG. 18 illustrates a block diagram of a communication apparatus according to an embodiment of the present invention.

In particular, FIG. 18 is a diagram showing the UE of FIG. 17 more specifically.

Referring to FIG. 18, the UE may include a processor (or digital signal processor (DSP)) 1810, an RF module (or RF unit) 1835, a power management module 1805, an antenna 1840, a battery 1855, a display 1815, a keypad 1820, a memory 1830, a subscriber identification module (SIM) card 1825 (this element is optional), a speaker 1845, and a microphone 1850. The UE may further include a single antenna or multiple antennas.

The processor 1810 implements the function, process and/or method proposed in FIGS. 1 to 17. The layers of a radio interface protocol may be implemented by the processor 1810.

The memory 1830 is connected to the processor 1810, and stores information related to the operation of the processor 1810. The memory 1830 may be positioned inside or outside the processor 1810 and may be connected to the processor 1810 by various well-known means.

A user inputs command information, such as a telephone number, by pressing (or touching) a button of the keypad 1820 or through voice activation using the microphone 1850, for example. The processor 1810 receives such command information and performs processing so that a proper function, such as making a phone call to the telephone number, is performed. Operational data may be extracted from the SIM card 1825 or the memory 1830. Furthermore, the processor 1810 may recognize and display command information or driving information on the display 1815, for convenience sake.

The RF module 1835 is connected to the processor 1810 and transmits and/or receives RF signals. The processor 1810 delivers command information to the RF module 1835 so that the RF module 1835 transmits a radio signal that forms voice communication data, for example, in order to initiate communication. The RF module 1835 includes a receiver and a transmitter in order to receive and transmit radio signals. The antenna 1840 functions to transmit and receive radio signals. When a radio signal is received, the RF module 1835 delivers the radio signal so that it is processed by the processor 1810, and may convert the signal into a baseband. The processed signal may be converted into audible or readable information output through the speaker 1845.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention may be achieved by various means, for example, hardware, firmware, software, or a combination thereof. In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The present invention is applied to a 3GPP LTE/LTE-A/5G (NextGen) system is primarily described, but can be applied to various wireless communication systems in addition to the 3GPP LTE/LTE-A/5G (NextGen) system.

1. A method of supporting vehicle to anything (V2X) communication of a second user equipment (UE) by a first UE in a wireless communication system, the method comprising:
receiving, from the second UE, a first request message to request mapping information on V2X service, wherein the mapping information comprises a Destination Layer-2 ID mapped to the V2X service;
transmitting, to a V2X control function, a second request message to request the mapping information;
receiving, from the V2X control function, a second response message comprising the mapping information as a response to the second request message; and
generating a first response message comprising the received mapping information and transmitting the first response message to the second UE as a response to the first request message.

2. The method of claim 1,
wherein the Destination Layer-2 ID corresponds to an identifier for identifying a protocol data unit, provided with respect to the V2X service, by the second UE.

3. The method of claim 2,
wherein the second request message comprises identification information on the second UE.

4. The method of claim 2,
wherein the second request message is a message used in a V2X authorization procedure for searching for a V2X communication parameter from the V2X control function.

5. The method of claim 4,
wherein a reception of the first request message is configured as a condition for initiating the V2X authorization procedure by the first UE.

6. The method of claim 4,
wherein the first request message and the first response message are transmitted through a PC5 reference point, and
wherein the second request message and the second response message are transmitted through a V3 reference point.

7. The method of claim 6,
wherein the PC5 reference point corresponds to a reference point defined between UEs for the V2X communication, and
wherein the V3 reference point corresponds to a reference point defined between a UE and the V2X control function for the V2X authorization.

8. The method of claim 7, further comprising:
transmitting the mapping information to a third UE at a preset time and/or in a preset period.

9. The method of claim 8,
wherein information on the preset time and/or the preset period is received through the second response message.

10. The method of claim 2,
wherein the second UE corresponds to a receive-only mode UE or a UE located in out-of-coverage (OOC).

11. The method of claim 2,
wherein the mapping information further comprises identification information on the V2X service, information on an area where the V2X service is used and/or valid period information of the V2X service.

12. A first user equipment (UE) supporting vehicle to anything (V2X) communication of a second UE in a wireless communication system, the first UE comprising:
a communication module configured to transmit and receive signals; and
a processor configured to control the communication module,
wherein the processor is configured to:
receive, from the second UE, a first request message to request mapping information on V2X service, wherein the mapping information comprises a Destination Layer-2 ID mapped to the V2X service;
transmit, to a V2X control function, a second request message to request the mapping information;
receive, from the V2X control function, a second response message comprising the mapping information as a response to the second request message; and
generate a first response message comprising the received mapping information and transmit the first response message to the second UE as a response to the first request message.

13. The first UE of claim 12,
wherein the Destination Layer-2 ID corresponds to an identifier for identifying a protocol data unit, provided with respect to the V2X service, by the second UE.

14. The first UE of claim 13,
wherein the second request message comprises identification information on the second UE.

15. The first UE of claim 13,
wherein the second request message is a message used in a V2X authorization procedure for searching for a V2X communication parameter from the V2X control function.
